(19) United States
(12) Patent Application Publication
(10) Pub. No.: US 2026/0203583 A1
(43) Pub. Date: Jul. 16, 2026

(54) ADAPTIVE CONTROL AND RECONFIGURATION OF NEURAL NETWORK ARCHITECTURES DURING INFERENCE

(71) Applicant: QUALCOMM Incorporated, San Diego, CA (US)

(72) Inventors: Mustafa KESKIN, San Diego, CA (US); Lindsey Makana KOSTAS, San Diego, CA (US); Andriy TEMKO, Ballincollig (IE)

(21) Appl. No.: 19/020,945

(22) Filed: Jan. 14, 2025

(51) Int. Cl. G06N 3/082; G06N 3/0495

(52) U.S. Cl. CPC G06N 3/082; G06N 3/0495

(57) ABSTRACT

Systems and techniques are provided for performing adaptive and/or on-the-fly throttling to reconfigure one or more layers of a machine learning architecture during inference. A process can include obtaining sensor data from sensors of a processing system configured to implement a neural network (NN) model comprising a plurality of layers and skip connections. Based on the sensor data, one or more skip connections corresponding to a respective skippable portion of the NN model can be determined. While the processing system performs inference using the NN model, the processing system can control the one or more skip connections to implement a reduced configuration of the NN model, where the reduced configuration of the NN model is implemented based on a reconfiguration of the NN model during the inference.

### FIELD

The present disclosure generally relates to machine learning networks. For example, aspects of the present disclosure relate to systems and techniques for throttling and/or re-configuring one or more layers of a machine learning network during inference.

### BACKGROUND

Many devices and systems allow video data to be processed and output for consumption. Digital video data includes large amounts of data to meet the demands of consumers and video providers. For example, consumers of video data desire high quality video, including high fidelity, resolutions, frame rates, and the like. As a result, the large amount of video data that is required to meet these demands places a burden on communication networks and devices that process and store the video data.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. For example, convolutional neural networks are able to extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing adaptive and/or on-the-fly throttling to reconfigure one or more layers of a machine learning architecture during inference. According to at least one illustrative example, a method is provided, the method including: obtaining sensor data from one or more sensors of a processing system, wherein the processing system is configured to implement a neural network (NN) model comprising a plurality of layers and a plurality of skip connections; determining, based on the sensor data, one or more skip connections from the plurality of skip connections, wherein the one or more skip connections correspond to a respective skippable portion of the NN model; and controlling the one or more skip connections while the processing system performs inference using the NN model, wherein the processing system is configured to control the one or more skip connections to implement a reduced configuration of the NN model, and wherein the reduced configuration of the NN model is implemented based on a reconfiguration of the NN model during the inference.

In another illustrative example, an apparatus for performing adaptive and/or on-the-fly throttling to reconfigure one or more layers of a machine learning architecture during inference is provided. The apparatus includes at least one memory and at least one processor coupled to the at least one memory and configured to: obtain sensor data from one or more sensors of the apparatus, wherein the apparatus is configured to implement a neural network (NN) model comprising a plurality of layers and a plurality of skip connections; determine, based on the sensor data, one or more skip connections from the plurality of skip connections, wherein the one or more skip connections correspond to a respective skippable portion of the NN model; and control the one or more skip connections while the processing system performs inference using the NN model, wherein the processing system is configured to control the one or more skip connections to implement a reduced configuration of the NN model, and wherein the reduced configuration of the NN model is implemented based on a reconfiguration of the NN model during the inference.

In another example, a non-transitory computer-readable medium is provided that includes instructions that, when executed by at least one processor, cause the at least one processor to: obtain sensor data from one or more sensors of the apparatus, wherein the apparatus is configured to implement a neural network (NN) model comprising a plurality of layers and a plurality of skip connections; determine, based on the sensor data, one or more skip connections from the plurality of skip connections, wherein the one or more skip connections correspond to a respective skippable portion of the NN model; and control the one or more skip connections while the processing system performs inference using the NN model, wherein the processing system is configured to control the one or more skip connections to implement a reduced configuration of the NN model, and wherein the reduced configuration of the NN model is implemented based on a reconfiguration of the NN model during the inference.

In another example, an apparatus is provided. The apparatus includes: means for obtaining sensor data from one or more sensors of a processing system, wherein the processing system is configured to implement a neural network (NN) model comprising a plurality of layers and a plurality of skip connections; means for determining, based on the sensor data, one or more skip connections from the plurality of skip connections, wherein the one or more skip connections correspond to a respective skippable portion of the NN model; and means for controlling the one or more skip connections while the processing system performs inference using the NN model, wherein the processing system is configured to control the one or more skip connections to implement a reduced configuration of the NN model, and wherein the reduced configuration of the NN model is implemented based on a reconfiguration of the NN model during the inference

In some aspects, one or more of the apparatuses described herein is, is part of, or includes a mobile device (e.g., a mobile telephone or so-called “smart phone”, a tablet computer, or other type of mobile device), a wearable device, an extended reality (XR) device (e.g., a virtual reality (VR) device, an augmented reality (AR) device, or a mixed reality (MR) device), a vehicle (or a computing device of a vehicle), a personal computer, a laptop computer, a video server, a television (e.g., a network-connected television), or other device. In some aspects, the apparatus includes at least one camera for capturing one or more images or video frames. For example, the apparatus(es) can include a camera (e.g., a red-green-blue (RGB) camera) or multiple cameras for capturing one or more images and/or one or more videos including video frames. In some aspects, the apparatus(es) includes a display for displaying one or more images, videos, notifications, or other displayable data. In some aspects, the apparatus(es) includes at least one transmitter (or at least one transceiver) configured to transmit one or more video frame and/or syntax data over a transmission medium to at least one device. In some aspects, the at least one processor of the apparatus noted above includes a neural processing unit (NPU), a central processing unit (CPU), a digital signal processor (DSP), a graphics processing unit (GPU), or other processing device or component.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SOC), in accordance with some examples;

FIGS. 2A-C illustrate respective examples of a fully connected, locally connected, and convolutional neural network, in accordance with some examples;

FIG. 3 is a block diagram illustrating an example of a deep learning network, in accordance with some examples;

FIG. 4 is a block diagram illustrating an example of a convolutional neural network, in accordance with some examples;

FIG. 5 is a block diagram illustrating a deep convolutional network (DCN), in accordance with some examples;

FIG. 6 is a block diagram illustrating an example of a machine learning network architecture including a plurality of layers segmented into one or more sections that can be dynamically adjusted and/or reconfigured to provide different accuracy and/or power dissipation based on sensor data inputs, in accordance with some examples;

FIG. 7 is a block diagram illustrating an example of a machine learning network architecture including a plurality of layers segmented into one or more sections that can be dynamically adjusted and/or reconfigured to provide different accuracy and/or power dissipation based on one or more learnable thresholds implemented by an auxiliary neural network, in accordance with some examples;

FIG. 8 is a diagram illustrating an example of an individually controlled power collapsable multiply-accumulate (MAC) unit that can be used to implement one or more skip layers and/or skip connections for a machine learning network architecture, in accordance with some examples;

FIG. 9 is a diagram illustrating an example of on-the-fly power collapse performed for one or more skip connections and/or skippable layer portions of a machine learning network architecture, where the power collapse is performed during inference by the machine learning network architecture and based on battery level or temperature sensor data inputs, in accordance with some examples;

FIG. 10 is a diagram illustrating an example of an iterative training process flow that may be implemented based on iteratively freezing different layers and/or skip connections of the machine learning network architecture, in accordance with some examples;

FIG. 11 is a flow chart diagram illustrating an example of a process for simulation parameter optimization, in accordance with some examples;

FIG. 12 illustrates an example computing device architecture of an example computing device which can implement the various techniques described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Neural network (NN) machine learning models have advanced and evolved rapidly, and continue to increase in complexity. Various neural network machine learning architectures can include convolutional neural networks (CNNs), deep neural networks (DNNs), recurrent neural networks (RNNs), and/or Transformer-based model architectures, etc., among various others. In some examples, increases in accuracy and/or other performance metrics measured for various neural network architectures and tasks can be associated with a corresponding increase in hardware resource utilization when running the model inference. For example, the hardware resource utilization of a neural network machine learning model can correspond to information such as memory footprint, number of model parameters (e.g., model size), operations count, batch size, maximum net memory utilization for batches of different size, inference time, power consumption, etc., among various others.

In some examples, the complexity of a neural network or other machine learning model can be proportional to the number of layers and parameters used by the model. The number of layers and the number of parameters can correspond to or otherwise impact the number of operations required for each forward pass of the model during inference. Increasing the model depth and parameters counts may be seen to allow neural networks to capture more patterns or relationships in input data, improve overall accuracy, and improve generalization to unseen data. However, this increasing model size can correspond to increased computational demands to run the model. For example, a single forward pass in a CNN with tens of layers and millions of parameters corresponds to performing billions of floating-point operations. To meet the compute demands of models with increased complexity (e.g., increased depth/number of layers, increased number of parameters, increased number of operations, etc.), processing hardware performance can be improved to increase the number of calculations that can be performed per second. Another approach is to increase the amount or quantity of processing hardware used, thereby also increasing the number of calculations that can be performed per second.

Many devices (e.g., such as smartphones, laptops, personal computing devices, user computing devices, etc.) are constrained by various factors that limit the maximum computational performance that can be achieved by the device. For example, devices can be size or area-constrained to a threshold silicon area available to implement the processing hardware. Battery-powered devices may be power constrained or limited. Many devices are also thermally constrained to limit model performance to prevent damage to the device itself (e.g., hardware damage, thermal runaway events, etc.) and/or to prevent hazards to the user - both of which may occur due to challenges in supplying sufficient power dissipation during high energy consumption processing events at the device, such as when running large and/or complex neural networks and other machine learning models. For example, power dissipation can be a major bottleneck on model performance, particularly in devices utilizing multiple switched mode power supplies (SMPS) with multiple phases delivering power to edge devices and other computing devices outside of high-performance data center environments specifically designed to handle the very large energy consumption and heat dissipation requirements associated with complex/large neural networks and other machine learning models during inference.

One approach for managing the thermal requirements and power dissipation needs for neural networks and other machine learning models running on different types or classes of devices is model scaling, which can be used to increase or decrease a machine learning architecture along one or multiple dimensions. For example, scaling a model architecture in width can correspond to increasing or decreasing the number of neurons per layer; depth scaling can correspond to increasing or decreasing the number of layers; resolution scaling can correspond to increasing or decreasing the resolution of the input/output data of the model, and therefore the number of operations performed by the model. Existing approaches to model scaling are often based on storing, in device memory (e.g., DRAM), the corresponding weights and biases and other architecture-specific information for a plurality of different model sizes, scales, and/or complexities. Model scaling can correspond to a device loading and configuring a new or different model architecture every time the model scale is switched along one or more dimensions. For example, model scaling to halve the width dimension can correspond to a device switching from a first NN model architecture with width x, to a second NN model architecture with the width x/2.

Loading a new or different model architecture from memory can be an expensive operation in terms of the energy consumption of the device. For example, the device can store the corresponding weights and biases and other architecture-specific information in memory, such as DRAM, for each different model scale that may be switched between. To switch between different models (e.g., to implement model scaling), the device may access the DRAM to fetch and retrieve the data; transfer the data; and write the transferred data for all of the weight and bias changes in the model to the corresponding register files (RFs) of the ALUs (arithmetic logic units) of the NPU (neural processing unit), GPU, etc., that is used to run the model. Accessing on-device memory to read, retrieve, and upload (e.g., implement) a large number of weight and bias changes for a neural network model can correspond to a high energy cost or consumption event for the device. For example, loading a new or different model architecture from memory can correspond to a device performing a series of events that have a cumulative and/or individual energy cost or consumption that is relatively high. It can be beneficial for devices to reduce the energy cost or energy consumption associated with implementing machine learning, including for battery-powered or other resource constrained devices having a limited power supply. There is a need for systems and techniques that can be used to implement dynamic control and/or reconfiguration of a neural network or other machine learning model architecture directly and on-the-fly, without the burden of uploading new and different models as described above. There is a further need for systems and techniques that can be used to implement dynamic control and/or reconfiguration of a neural network or other machine learning model architecture with no memory interaction (e.g., without accessing the device memory and/or without performing data movement operations to upload the weights and/or biases of the new model).

Systems, apparatuses, methods (also referred to as processes), and computer-readable media (collectively referred to as “systems and techniques”) are described herein that can be used to perform dynamic configuration and/or reconfiguration of one or more layers, or portions thereof, included in a machine learning network. The machine learning network can be a neural network, a deep neural network, etc. The dynamic configuration and/or reconfiguration can correspond to one or more skip connections and/or skip layers included in the machine learning network. For example, the dynamic configuration and/or reconfiguration can be implemented based on activating or deactivating various combinations or configurations of a plurality of skip connections and/or skip layers of the machine learning network. In some examples, the dynamic configuration and/or reconfiguration can be performed during inference by the machine learning network. For example, the systems and techniques can provide on-the-fly throttling, configuration, re-configuration, etc., to increase or decrease a power or energy consumption of the machine learning network inference operations. In some examples, the systems and techniques can provide on-the-fly throttling, configuration, re-configuration, etc., to increase or decrease a thermal footprint or thermal load associated with a device performing the inference using the machine learning network.

For example, the systems and techniques can be used to dynamically and quickly (e.g., with low latency) change the architecture of a neural network or other machine learning model that is performing inference. The neural network or machine learning model may initiate the inference operations while using a first configuration of the one or more skip connections and internal layers of the model. Subsequently, during inference (e.g., without stopping the performance of inference by the model), the systems and techniques may be used to implement one or more model architecture changes to reconfigure at least a portion of the one or more skip connections and internal layers of the model. Implementing the one or more model architecture changes can be performed on-the-fly during inference, based on activating and/or deactivating respective skip connections or skip layers within the machine learning model architecture. For example, a set of skip connections can be deactivated to reduce a power consumption and/or thermal load associated with the machine learning model performing the inference operations. In another example, a set of skip connections can be activated to increase a performance or computational power associated with the machine learning model performing the inference operations.

In some examples, a processing device that is used to implement a neural network or other machine learning model or architecture can include a plurality of sensors. The plurality of sensors can be sensors included in or implemented by the device (e.g., temperature sensors, imaging sensors, microphones or audio sensors, etc., of a smartphone, laptop, user computing device, etc.). One or more sensors of the plurality of sensors can include on-chip sensors associated with an implementation of the processing device and/or the neural network or machine learning model architecture (e.g., on-chip sensors such as process sensors, voltage sensors, temperature sensors, frequency sensors, and/or current sensors, etc., among various others). The plurality of sensors can include one or more sensors that are implemented by a processing component within the device (e.g., sensors on an SOC, CPU, GPU, NPU, etc., that is configured to execute the machine learning model and/or to perform inference using the machine learning model, etc.). The systems and techniques can be configured to use sensor data from the one or more sensors to control the skip connections and/or skip layers of the machine learning model architecture (e.g., can be configured to use the sensor data to implement throttling, adaptive configuration or reconfiguration, etc.) during inference performed using the machine learning model. In some examples, controlling the skip connections and/or skippable layers of the machine learning network can be implemented using low-level hardware or analog logic of the processing device. In some examples, controlling the skip connections and/or skippable layers of the machine learning network can be implemented based on one or more learnable thresholds determined at least in part by an auxiliary neural network using the sensor data as input to determine or predict a control output for activating or deactivating respective skip connections of the machine learning model architecture.

In some cases, the systems and techniques can be configured to directly control one or more skip connections and/or groups of skip layers of a neural network or other machine learning model architecture, based on respective sensor data obtained from one or more sensors of the processing device. For example, sensor data or sensor measurements can be used to perform on-the-fly and dynamic throttling of the neural network for power and thermal mitigation during inference. In some cases, the skip connection layers can be used for power collapse for throttling or dynamically sectioning layers of the neural network during inference. Power collapse can be performed to fully power off the one or more layers or sections of the neural network (e.g., full power collapse), and/or power collapse can be performed to partially power off the one or more layers or sections of the neural network (e.g., retention or V_{dd,min}, etc.) In some examples, power collapse for throttling or dynamically sectioning layers of the neural network during inference can include various combinations of full power collapse (e.g., performed for a first subset of neural network layers or portions) and partial power collapse (e.g., performed for a second subset of neural network layers or portions). For example, the device sensor data can be used to control the power supply associated with processing operations, ALUs, etc., that are configured to implement the processing operations corresponding to skip connection layers of the model architecture. Activating the skip connection can correspond to deactivating or dropping the power supply to the group of one or more layers associated with the skip connection. For example, the data processing flow of the NN model skips the group of one or more layers associated with an activated skip connection, and the electrical power supply/electrical flow for implementing the NN model in the hardware of the device can skip powering this same group of one or more layers associated with the activated skip connection.

Various aspects of the present disclosure will be described with respect to the figures.

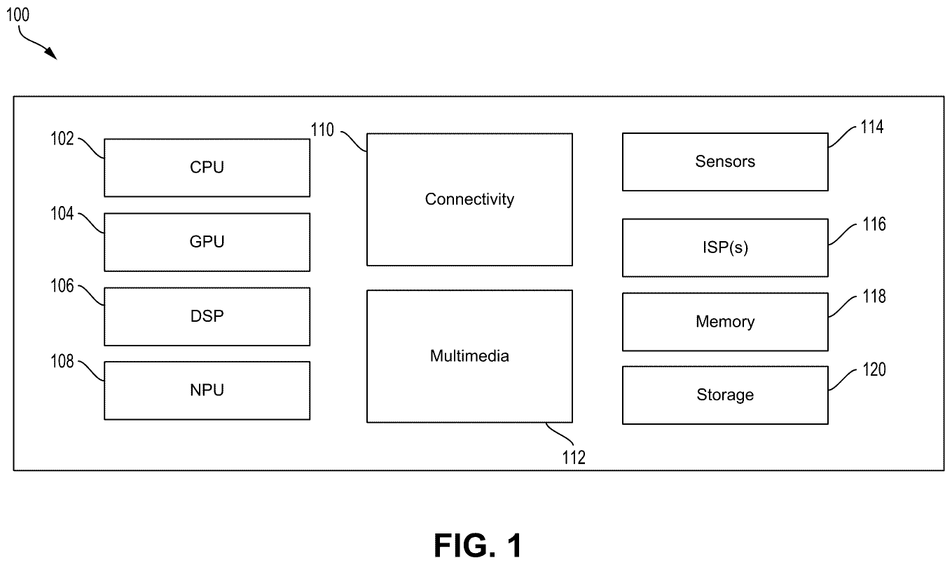

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In some implementations, the NPU is implemented in the CPU 102, DSP 106, and/or GPU 104. The SOC 100 may also include a sensor processor 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

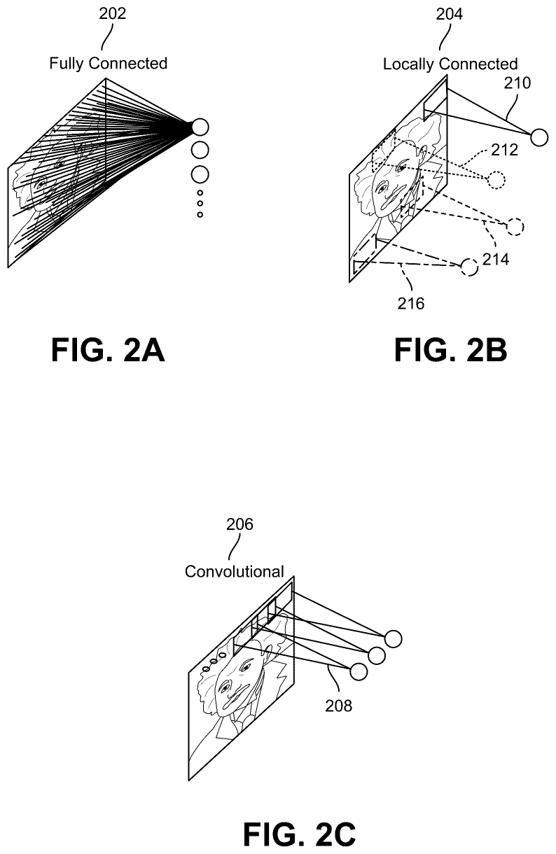

The connections between layers of a neural network may be fully connected or locally connected. FIG. 2A illustrates an example of a fully connected neural network 202. In a fully connected neural network 202, a neuron in a first hidden layer may communicate its output to every neuron in a second hidden layer, so that each neuron in the second layer will receive input from every neuron in the first layer. FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

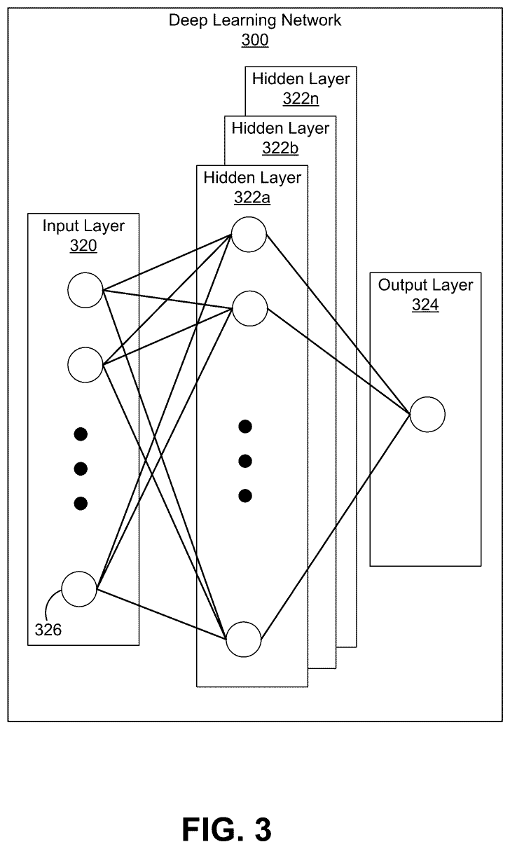

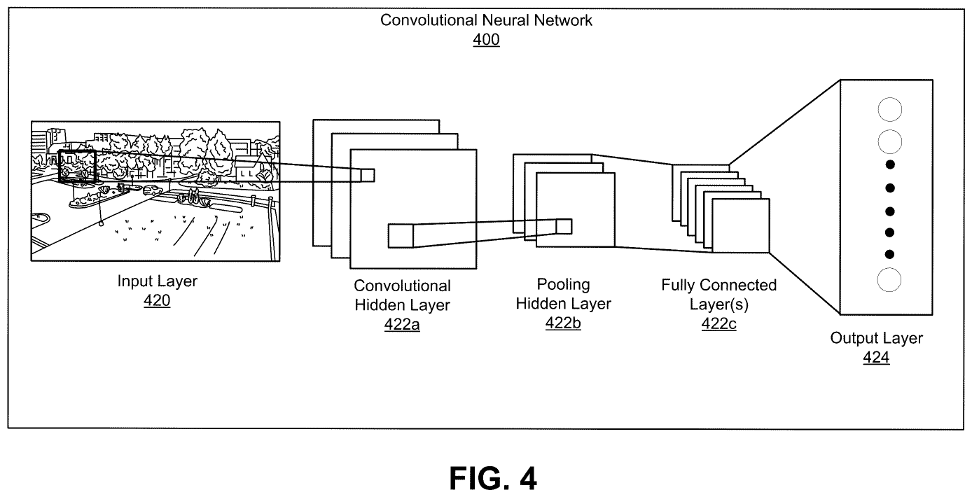

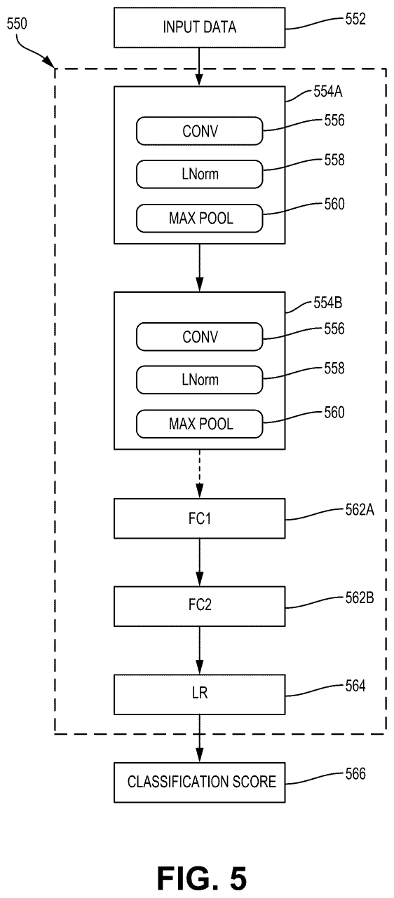

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. An illustrative example of a deep learning network is described in greater depth with respect to the example block diagram of FIG. 3. Illustrative examples of convolutional neural networks are described in greater depth with respect to the example block diagrams of FIGS. 4-5.

FIG. 3 is an illustrative example of a deep learning neural network 300. An input layer 320 includes input data. In some cases, the input layer 320 can include data representing the pixels of an input video frame. The neural network 300 includes multiple hidden layers 322a, 322b, through 322n. The hidden layers 322a, 322b, through 322n include “n” number of hidden layers, where “n” is an integer greater than or equal to one. The number of hidden layers can be made to include as many layers as needed for the given application. The neural network 300 further includes an output layer 324 that provides an output resulting from the processing performed by the hidden layers 322a, 322b, through 322n. In some aspects, the output layer 324 can provide a classification for an object in an input video frame. The classification can include a class identifying the type of object (e.g., a person, a dog, a cat, or other object).

The neural network 300 is a multi-layer neural network of interconnected nodes. Each node can represent a piece of information. Information associated with the nodes is shared among the different layers and each layer retains information as information is processed. In some cases, the neural network 300 can include a feed-forward network, in which case there are no feedback connections where outputs of the network are fed back into itself. In some cases, the neural network 300 can include a recurrent neural network, which can have loops that allow information to be carried across nodes while reading in input.

Information can be exchanged between nodes through node-to-node interconnections between the various layers. Nodes of the input layer 320 can activate a set of nodes in the first hidden layer 322a. For example, as shown, each of the input nodes of the input layer 320 is connected to each of the nodes of the first hidden layer 322a. The nodes of the hidden layers 322a, 322b, through 322n can transform the information of each input node by applying activation functions to the information. The information derived from the transformation can then be passed to and can activate the nodes of the next hidden layer 322b, which can perform their own designated functions. Example functions include convolutional, up-sampling, data transformation, and/or any other suitable functions. The output of the hidden layer 322b can then activate nodes of the next hidden layer, and so on. The output of the last hidden layer 322n can activate one or more nodes of the output layer 324, at which an output is provided. In some cases, while nodes (e.g., node 326) in the neural network 300 are shown as having multiple output lines, a node has a single output and all lines shown as being output from a node represent the same output value.

In some cases, each node or interconnection between nodes can have a weight that is a set of parameters derived from the training of the neural network 300. Once the neural network 300 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 300 to be adaptive to inputs and able to learn as more and more data is processed.

The neural network 300 is pre-trained to process the features from the data in the input layer 320 using the different hidden layers 322a, 322b, through 322n in order to provide the output through the output layer 324. In an example in which the neural network 300 is used to identify objects in images, the neural network 300 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 300 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 300 is trained well enough so that the weights of the layers are accurately tuned.

The neural network 300 can include any suitable deep network. One example includes a convolutional neural network (CNN), which includes an input layer and an output layer, with multiple hidden layers between the input and out layers. An example of a CNN is described below with respect to FIG. 4. The hidden layers of a CNN include a series of convolutional, nonlinear, pooling (for downsampling), and fully connected layers. The neural network 300 can include any other deep network other than a CNN, such as an autoencoder, a deep belief nets (DBNs), a Recurrent Neural Networks (RNNs), among others.

FIG. 4 is an illustrative example of a convolutional neural network 400 (CNN 400). The input layer 420 of the CNN 400 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 422a, an optional non-linear activation layer, a pooling hidden layer 422b, and fully connected hidden layers 422c to get an output at the output layer 424. While only one of each hidden layer is shown in FIG. 4, multiple convolutional hidden layers, non-linear layers, pooling hidden layers, and/or fully connected layers can be included in the CNN 400. As previously described, the output can indicate a single class of an object or can include a probability of classes that best describe the object in the image.

The first layer of the CNN 400 is the convolutional hidden layer 422a. The convolutional hidden layer 422a analyzes the image data of the input layer 420. Each node of the convolutional hidden layer 422a is connected to a region of nodes (pixels) of the input image called a receptive field. The convolutional hidden layer 422a can be considered as one or more filters (each filter corresponding to a different activation or feature map), with each convolutional iteration of a filter being a node or neuron of the convolutional hidden layer 422a. For example, the region of the input image that a filter covers at each convolutional iteration would be the receptive field for the filter. In some aspects, if the input image includes a 28×28 array, and each filter (and corresponding receptive field) is a 5×5 array, then there will be 24×24 nodes in the convolutional hidden layer 422a. Each connection between a node and a receptive field for that node learns a weight and, in some cases, an overall bias such that each node learns to analyze its particular local receptive field in the input image. Each node of the hidden layer 422a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 422a is due to each node of the convolutional layer being applied to its corresponding receptive field. For example, a filter of the convolutional hidden layer 422a can begin in the top-left corner of the input image array and can convolve around the input image. As noted above, each convolutional iteration of the filter can be considered a node or neuron of the convolutional hidden layer 422a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 422a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 422a.

The mapping from the input layer to the convolutional hidden layer 422a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 422a can include several activation maps in order to identify multiple features in an image. The example shown in FIG. 4 includes three activation maps. Using three activation maps, the convolutional hidden layer 422a can detect three different kinds of features, with each feature being detectable across the entire image.

In some examples, a non-linear hidden layer can be applied after the convolutional hidden layer 422a. The non-linear layer can be used to introduce non-linearity to a system that has been computing linear operations. An example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 400 without affecting the receptive fields of the convolutional hidden layer 422a.

The pooling hidden layer 422b can be applied after the convolutional hidden layer 422a (and after the non-linear hidden layer when used). The pooling hidden layer 422b is used to simplify the information in the output from the convolutional hidden layer 422a. For example, the pooling hidden layer 422b can take each activation map output from the convolutional hidden layer 422a and generates a condensed activation map (or feature map) using a pooling function. Max-pooling is an example of a function performed by a pooling hidden layer. Other forms of pooling functions be used by the pooling hidden layer 422a, such as average pooling, L2-norm pooling, or other suitable pooling functions. A pooling function (e.g., a max-pooling filter, an L2-norm filter, or other suitable pooling filter) is applied to each activation map included in the convolutional hidden layer 422a. In the example shown in FIG. 4, three pooling filters are used for the three activation maps in the convolutional hidden layer 422a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 422a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 422a having a dimension of 24×24 nodes, the output from the pooling hidden layer 422b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output. Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 400.

The final layer of connections in the network is a fully-connected layer that connects every node from the pooling hidden layer 422b to every one of the output nodes in the output layer 424. Using the example above, the input layer includes 28×28 nodes encoding the pixel intensities of the input image, the convolutional hidden layer 422a includes 3×24×24 hidden feature nodes based on application of a 5×5 local receptive field (for the filters) to three activation maps, and the pooling layer 422b includes a layer of 3×12×12 hidden feature nodes based on application of max-pooling filter to 2×2 regions across each of the three feature maps. Extending this example, the output layer 424 can include ten output nodes. In such an example, every node of the 3×12×12 pooling hidden layer 422b is connected to every node of the output layer 424.

The fully connected layer 422c can obtain the output of the previous pooling layer 422b (which should represent the activation maps of high-level features) and determines the features that most correlate to a particular class. For example, the fully connected layer 422c layer can determine the high-level features that most strongly correlate to a particular class, and can include weights (nodes) for the high-level features. A product can be computed between the weights of the fully connected layer 422c and the pooling hidden layer 422b to obtain probabilities for the different classes. For example, if the CNN 400 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person). In some examples, the output from the output layer 424 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some cases, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

One type of convolutional neural network is a deep convolutional network (DCN). Another example of a convolutional neural network is a deep belief networks (DBN). DBNs are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information associated with the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods. For example, a DCN may be trained with supervised learning. During training, a DCN may be presented with an image, such as a cropped image of a speed limit sign, and a “forward pass” may then be computed to produce an output. The output may be a vector of values corresponding to features. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network. In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output that may be considered an inference or a prediction of the DCN.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections. The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layers, with each element of the feature map receiving input from a range of neurons in the previous layer and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

FIG. 5 is a block diagram illustrating an example of a deep convolutional network (DCN) 550. The deep convolutional network 550 may include multiple different types of layers based on connectivity and weight sharing. As shown in FIG. 5, the deep convolutional network 550 includes the convolution blocks 554A, 554B. Each of the convolution blocks 554A, 554B may be configured with a convolution layer (CONV) 556, a normalization layer (LNorm) 558, and a max pooling layer (MAX POOL) 560.

The convolution layers 556 may include one or more convolutional filters, which may be applied to the input data 552 to generate a feature map. Although only two convolution blocks 554A, 554B are shown, the present disclosure is not so limiting, and instead, any number of convolution blocks (e.g., blocks 554A, 554B) may be included in the deep convolutional network 550 according to design preference. The normalization layer 558 may normalize the output of the convolution filters. For example, the normalization layer 558 may provide whitening or lateral inhibition. The max pooling layer 560 may provide down sampling aggregation over space for local invariance and dimensionality reduction.

The parallel filter banks, for example, of a deep convolutional network may be loaded on a CPU or GPU of an SOC (e.g., such as the CPU 102 or GPU 104 of the SOC 100 of FIG. 1, etc.) to achieve high performance and low power consumption. In alternative aspects, the parallel filter banks may be loaded on the DSP 106 or an ISP 56 of the SOC 100 of FIG. 1. In addition, the deep convolutional network 550 may access other processing blocks that may be present on the SOC 100 of FIG. 1, such as sensor processor 114 and storage 120, etc.

The deep convolutional network 550 may also include one or more fully connected layers, such as layer 562A (labeled “FC1”) and layer 562B (labeled “FC2”). The deep convolutional network 550 may further include a logistic regression (LR) layer 564. Between each layer 556, 558, 560, 562A, 562B, 564 of the deep convolutional network 550 are weights (not shown) that are to be updated. The output of each of the layers (e.g., 556, 558, 560, 562A, 562B, 564) may serve as an input of a succeeding one of the layers (e.g., 556, 558, 560, 562A, 562B, 564) in the deep convolutional network 550 to learn hierarchical feature representations from input data 552 (e.g., images, audio, video, sensor data and/or other input data) supplied at the first of the convolution blocks 554A. The output of the deep convolutional network 550 is a classification score 566 for the input data 552. The classification score 566 may be a set of probabilities, where each probability is the probability of the input data including a feature from a set of features.

Various neural network architectures may include one or more skip connections provided between various portions of one or more layers of the neural network, and/or provided between the layers themselves of the neural network. Skip connections can be implemented as feed-forward skip connections between an input layer or input portion of the neural network, and an output layer or output portion of the neural network. In some examples, skip connections can be implemented as feedback skip connections between an output layer or output portion of the neural network, and an input layer or input portion of the neural network. Skip connections can variously be configured as feedback or feedforward connections, and may be connected between various combinations of layers and/or portions thereof for one or more layers of a plurality of layers of a neural network architecture.

As noted above, various machine learning and/or neural network models, architectures, etc., can include one or more skip connections between respective layers and/or portions of layers included in a plurality of layers of the model architecture. For example, skip connections can be variously configured between input layers of the neural network, output layers of the neural network, internal or intermediate layers (e.g., hidden layers), etc., of the neural network model architecture. In some aspects, layers that include at least one skip connection, one or more skip connections, . . . , etc., may also be referred to as “skip layers,” “skip-connected layers,” “skippable layers,” etc., among various others. In some aspects, a neural network or machine learning architecture may utilize one or more skip connections between various internal or hidden layers. The internal or hidden layers of a machine learning network can be the layers that are neither input layers nor output layers of the machine learning network or model. In some cases, a skip connection of a deep neural network may be associated with residual learning for training the deep neural network. In some cases, skip connections and residual learning may be used interchangeably with reference to at least some DNN implementations (e.g., the skip connection in deep neural networks can be used for residual learning). For example, a residual learning block for a neural network model can be used to reformulate one or more layers as learning residual functions with reference to the inputs based on introducing a skip connection. In some cases, a residual learning block can include a residual unit and an identity map with a skip connection between the input to the residual unit and the output of the residual unit.

In some aspects, skip connections can be implemented with various lengths through or within a neural network model. In some cases, the length of a skip connection can refer to and/or may correspond to a length of the path through the network that is skipped by activating or using the skip connection. For example, the length of a skip connection can correspond to a number of layers within the neural network that are bypassed (e.g., skipped) by using the skip connection. In one illustrative example, skip connections can be used to bypass or skip one or multiple layers within the neural network architecture. For example, a skip connection between given first and second layer of the network can be used to bypass one or more layers that are otherwise connected along a path between the first and second given layers. In some cases, a fully convolutional neural network can use one or more skip connections to pass previous feature maps forward, from internal layers of the NN network to an output of a convolution layer. In one illustrative example, a fully convolutional neural network may include one or more skip connections that can be configured and used to pass previous feature maps forward and concatenate the previous feature maps with the last output of the convolution layer. Another example of a neural network architecture that can include and/or utilize one or more skip connections and/or skip layers is U-Net. For example, U-Net and/or U-Net-based architectures may implement long skip connections, which may refer to skip connections that bypass at least three internal layers of the model, to combine local information from an encoder side of the U-Net model architecture with context information from the decoder side of the U-Net model architecture. In some examples, skip connections and skip layers in neural network architectures can be used to improve linearity, and in some architectures both branches with regular NN layers and those with skip layers can be used together. Separately, some NN architectures can include drop-out and Identity layers, with the drop-out and Identity layers primarily used during training and test, and not in inference.

As noted above, the systems and techniques described herein can be used to perform adaptive and/or on-the-fly throttling to reconfigure one or more layers of a machine learning architecture during inference (e.g., performed as or while the machine learning architecture is used for inference processing). In some aspects, dynamic configuration and/or reconfiguration of the machine learning architecture can be applied to one or more layers that have a respective one or more skip connections that can be activated (e.g., to skip a corresponding portion of the layer, to skip the entire layer, to skip a group of layers including the layer, etc.) and/or deactivated (e.g., to use, or not skip, the corresponding portion of the layer, the entire layer, the group of layers including the layer, etc.). The dynamic configuration and/or reconfiguration can correspond to one or more skip connections and/or skip layers included in the machine learning network. For example, the dynamic configuration and/or reconfiguration can be implemented based on activating or deactivating various combinations or configurations of a plurality of skip connections and/or skip layers of the machine learning network. In some examples, the dynamic configuration and/or reconfiguration can be performed during inference by the machine learning network. For example, the systems and techniques can provide on-the-fly throttling, configuration, re-configuration, etc., to increase or decrease a power or energy consumption of the machine learning network inference operations. In some examples, the systems and techniques can provide on-the-fly throttling, configuration, re-configuration, etc., to increase or decrease a thermal footprint or thermal load associated with a device performing the inference using the machine learning network.

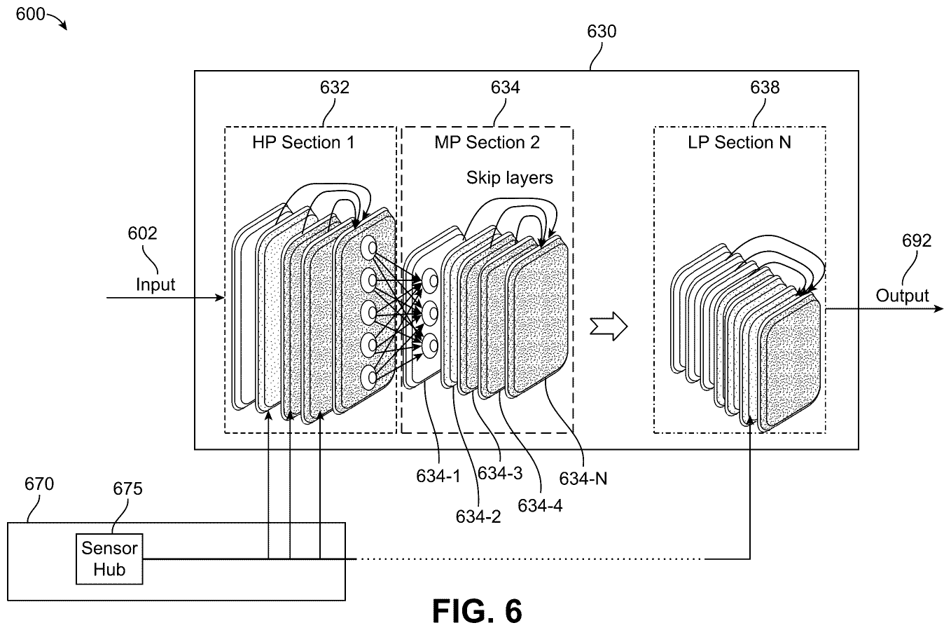

FIG. 6 is a block diagram illustrating an example of a machine learning system 600 that can be configured to perform dynamic adjustment and/or reconfiguration of an architecture (e.g., machine learning architecture) implemented by a machine learning network 630, in accordance with some examples. The machine learning network 630 (e.g., machine learning model) can be a neural network, a deep neural network, etc., among various others. The architecture of the machine learning network 630 can include a plurality of machine learning layers arranged between an input 602 and an output 692 of the machine learning network 630. For example, if the machine learning network 630 is an image analysis or image classification model, the input 602 can correspond to input image data and the output 692 can correspond to one or more classifications, predictions, etc., generated using the machine learning network 630 to perform inference processing relating to the input image data 602.

In one illustrative example, the machine learning network 630 can include an architecture comprising a plurality of machine learning layers, as noted above, where the plurality of machine learning layers can be segmented or divided into one or more sections (e.g., sub-sections) of the larger machine learning network 630. For example, the machine learning network 630 includes a first section 632, a second section 634, . . . , an N^{th} section 638, etc. In some examples, the plurality of machine learning layers are distributed across the N sections of the machine learning network 630, where each respective layer is included in one section.

In some cases, the systems and techniques can be used to implement adaptive and/or on-the-fly throttling to reconfigure one or more layers of the machine learning architecture implemented by the machine learning network 630 during inference. For example, the architecture dynamic adaptation(s) can be performed based on activating or deactivating respective sections of the plurality of sections included in the machine learning network 630, and/or can be performed based on activating or deactivating respective portions of layers, respective subsets of layers, etc., included within the individual sections included in the machine learning network 630, etc. For example, the systems and techniques can configure one or more skip connections associated with the machine learning network 630, the plurality of machine learning layers, and/or the plurality of sections within the machine learning network 630, to thereby perform or provide dynamic adjustment and/or reconfiguration of the architecture being implemented by the machine learning network 630 during ongoing inference processing operations. In some aspects, the dynamic or adaptive architecture adjustments for the machine learning network 630 can be based on sensor data obtained from a sensor hub 675 included in a processing device or other processing hardware used to implement and run the machine learning network 630 for the inference processing operations. In some examples, the dynamic or adaptive architecture adjustments for the machine learning network 630 can be performed to provide different accuracy and/or power dissipation (e.g., thermal performance, etc.) characteristics to the machine learning model 630 as the model executes on the processing device during inference. The systems and techniques can provide different accuracy and/or power dissipation based on sensor data inputs, in accordance with some examples.

In one illustrative example, the machine learning network 630 can be implemented using a processing device, a processing system, a computing device, a user computing device, etc., that includes one or more sensors configured to generate and/or measure respective hardware and/or environmental parameters associated with one or more of the processing device or surrounding environment where the processing device and/or sensors are located. For example, the one or more sensors can be hardware sensors configured to measure respective sensor values for hardware components included in the processing device. In another example, the one or more sensors can be hardware or environmental sensors such as microphones, ambient light sensors, cameras, imaging sensors, etc. In some aspects, the sensor hub 675 can include and/or correspond to the one or more sensors associated with the processing device and/or the machine learning network 630. For example, the sensor hub 675 may include the plurality of sensors. In some examples, the sensor hub 675 can be associated with the plurality of sensors and/or the respective sensor data outputs generated by the plurality of sensors. For example, the sensor hub 675 may include and/or implement a sensor data communication bus used to provide sensor data between the respective sensors of the processing device and the remaining or additional components of the processing device.

In some aspects, the sensor hub 675 can be included in a hardware layer 670 of the processing device used to implement the machine learning network 630. The hardware layer 670 can correspond to the low-level hardware implementation of various components, processing components, computing elements, engines, etc., of the processing device running the machine learning network 630, etc. As used herein, the hardware layer 670 may also be referred to as a “hardware system” or “hardware subsystem” 670 of the processing device used to implement the machine learning network 630. In one illustrative example, the hardware subsystem 670 of the processing device can include a power management integrated circuit (PMIC), where the PMIC is configured to control, configure, adjust, etc., the power supply to the various components of the processing device. In examples where the processing device is a battery-powered device (e.g., such as a UE, smartphone, user computing device, etc., among various other resource-constrained and/or power-constrained processing devices), the hardware subsystem 670 can include the battery and one or more PMICs and switches associated with distribution of the electrical energy from the battery or other power supply.

In some examples, a processing device that is used to implement a neural network or other machine learning model (e.g., the machine learning network 630, etc.) can include a plurality of sensors. The plurality of sensors can be included in the sensor hub 675 and/or hardware subsystem 670, and/or may be associated with the sensor hub 675 and/or hardware subsystem 670. In some aspects, the sensors included in or associated with the sensor hub 675 can be sensors included in or implemented by the processing device (e.g., temperature sensors, imaging sensors, microphones or audio sensors, etc., of a smartphone, laptop, user computing device, etc.). The sensors available to the processing device can also include one or more sensors that are implemented by a processing component within the device (e.g., sensors of an SOC, CPU, GPU, NPU, etc.).

In one illustrative example, the sensor hub 675 can be used to provide the dynamic and low latency control to configure and/or reconfigure the architecture of the machine learning network 630, based on using sensor output(s) and/or sensor values compared to corresponding configured threshold values to cause the sensor hub 675 and/or hardware subsystem 670 to activate or deactivate one or more skip connections within the various layers and sections 632, 634, . . . , 638 of the machine learning network 630 of FIG. 6.

In some examples, the systems and techniques may use one or more sensors (e.g., of the plurality of sensors associated with the processing device and/or the plurality of sensors included within or corresponding to the sensor hub 675, etc.) to directly control one or more skip connections and/or groups of skip layers of a neural network or other machine learning model architecture (e.g., machine learning network 630). For example, the sensor hub 675 can obtain and/or receive the respective sensor data or sensor measurements from the plurality of sensors, and can use the respective sensor data or measurement values to determine a dynamic architecture configuration for the machine learning network 630 given the current sensor inputs indicative of a current state or condition of the processing device and/or surrounding environment. A dynamic architecture configuration for the machine learning network 630 can include a respective indication to activate or an indication to deactivate each skip connection of a plurality of skip connections associated with (e.g., included within) the architecture of the machine learning network 630.

Determining and implementing a configuration of the skip connections of the machine learning network 630 model architecture can be used to perform on-the-fly and dynamic throttling of the neural network for power and thermal mitigation during inference. For example, increasing temperature values measured by a temperature sensor of the processing device can cause the sensor hub 675 to automatically and dynamically control the model architecture by activating additional skip connections that cause the inference processing operations to skip one or more layers (e.g., groups of neurons, etc.) of the machine learning network 630 architecture. In some aspects, activating a skip connection corresponds to selecting or using the skip connection. For example, activating a skip connection between the output layer of the first section 632 of the machine learning network 630 architecture and the input layer of the N^{th} section 638 can correspond to using the skip connection to bypass the section 634 therebetween. Deactivating a skip connection can correspond to not using the skip connection (e.g., not skipping the one or more layer or one or more layer portions). For example, deactivating a skip connection between the output layer of the first section 632 and the input layer of the N^{th} section 638 can correspond to not using the skip connection, such that the processing flow through the architecture of the machine learning network 630 proceeds from the output layer of the first section 632 to the input layer 634-1 of the second section 634.

In some examples, the plurality of layers of the machine learning network 630 can be grouped or divided into one or more sections, where each section includes a respective input layer (e.g., the first layer included in the section, where the respective input layer of a section is the layer that receives data provided from the immediately prior section and/or respective output layer thereof). Each section can further include a respective output layer (e.g., the last layer included in the section, where the respective output layer of a section is the layer that provides data to the immediately subsequent section and/or respective input layer thereof). Between the respective input and output layers of a section can be provided one or more internal layers of the section.

For example, the second section 634 can include an input layer 634-1, which may be used to receive the output from the output layer of the first section 632. The second section 634 further includes an output layer 634-N, which provides an output from the second section 634 to the respective input layer of the next section of layers include in the machine learning network 630. Between the input layer 634-1 and output layer 634-N, the second section 634 includes the set of internal machine learning layers (e.g., also referred to as hidden layers, etc.) 634-2, 634-3, 634-4, . . . , etc. In one illustrative example, a plurality of skip connections can be implemented for or by various combinations of the internal layers of a section, and/or portions (e.g., subsets, etc.) of the internal layers of a section. In some aspects, internal layers including one or more skip connections can also be referred to as “skip layers” or “skip connection layers” of the machine learning network 630 and the corresponding section that includes these one or more layers.

In some cases, the skip connection layers can be used for power collapse for throttling or dynamically sectioning layers of the neural network 630 during inference. For example, the device sensor data at the sensor hub 675 can be used to control the power supply to the respective logic units or other processing hardware (e.g., ALUs, etc.) that are configured to implement the processing operations for each group of neurons corresponding to respective skip connections.

In some aspects, using a skip connection to skip one or more layers or layer portions within the machine learning network 630 corresponds to performing a power collapse of the respective processing hardware or processing elements that are allocated for the layers being skipped. Performing the power collapse of the processing hardware allocated to sections of layers that are skipped by using a skip connection can correspond to cutting or reducing the supply of electrical power to this processing hardware. The mapping between the different skippable neurons and layers of the NN model architecture 630 and the respective power switching nodes or power supply lines to the allocated processing hardware for each of the skippable neurons and layers can be determined at the time of loading the NN model architecture from memory and implementing the loaded model in the processing hardware or processing engine of the device. Subsequently, the device can be configured to use the hardware subsystem 670 and sensor hub 675 to control the power supply lines to the underlying processing hardware allocated for different portions of the machine learning network 630 architecture, according to the activation or deactivation state of each skip connection of the plurality of skip connections.

For example, when a skip connection is not selected or used, the hardware subsystem 670 and sensor hub 675 are configured to control the power supply line to remain in an ‘ON’ or active state to deliver electrical power to the skippable layers associated with the skip connection (e.g., the skippable layers receive electrical power based on their corresponding skip connection not being used to skip the skippable layers). When the skip connection is selected and used, the hardware subsystem 670 and sensor hub 675 can be configured to control the power supply line to enter an ‘OFF’, inactive, idle, low-power, etc., state having a zero power consumption and/or a reduced power consumption that is less than during the active/ON state. For example, selecting and using the skip connection corresponding to a set of skippable layers or neurons corresponds to the set of skippable layers or neurons being skipped, and not used during the remaining inference processing operations of the machine learning network 630. Power collapse can be performed by the hardware subsystem 670 to de-energize or reduce the electrical power supply to the hardware configured to implement these skippable layers or neurons that have been selected to be skipped.

In some aspects, activating a skip connection can correspond to the hardware subsystem 670 and/or sensor hub 675 deactivating or dropping the power supply to the group of one or more layers associated with the skip connection. For example, the data processing flow of the NN model skips the group of one or more layers associated with an activated skip connection, and the electrical power supply/electrical flow for implementing the NN model in the hardware of the device can skip powering this same group of one or more layers associated with the activated skip connection.

Controlling the skip connections and skip layers of the NN model 630 architecture can be used for on-the-fly throttleable configurations and reconfigurations of the NN model 630, without requiring or performing memory interactions to retrieve weight or bias values of a scaled model from the device memory. In one illustrative example, the sensor data obtained by the sensors associated with the processing device and/or included in the sensor hub 675 can be used to control respective power supply connections for each layer of the NN model 630, where controlling the respective power supply connections corresponds to causing the hardware subsystem 670 (and/or a PMIC thereof) to cut or deactivate the power supply connections to the layers under an activated skip connection.

In some cases, a group of skip layers (e.g., such as a section of skip layers 632, 632, . . . , 638) can be throttled based on sensor data obtained from distributed temperature sensors associated with the processing device and/or included in the sensor hub 675. For example, in response to the temperature exceeding a first threshold value at the sensor hub 675, a first group of skip connections can be deactivated and may have their power supply disconnected by or within the hardware subsystem 670. Throttling of the NN model 630 running on the device during inference can be performed directly based on the sensor data or measurements, and can be performed dynamically and/or in real-time, without any DDR or on-device memory read to obtain and then load a new model configuration. In some examples, the plurality of layers of the NN model 630 architecture can be segmented according to one or more criteria or characteristics, including a power level and/or performance characteristics associated with the respective layers. In some aspects, the first section of layers 632 of the NN model 630 may include a subset of relatively high-power and/or high-performance layers (e.g., HP layers and/or an HP section) of the NN model 630. In some examples, the second section of layers 634 of the NN model 630 may include a subset of relatively moderate power and/or moderate performance layers (e.g., MP layers and/or an MP section) of the NN model 630. In some cases, the section of layers 634-N of the NN model 630 may include a subset of relatively low power and/or low performance layers (e.g., LP layers and/or an LP section) of the NN model 630. In some examples, control of skip connection layers can be implemented to perform throttling and/or activation/deactivation of some, or all, of the skippable layers within a respective section of layers of the NN model 630. For example, throttling of the HP section 632 of layers can include performing power collapse (e.g., full power collapse, partial power collapse, etc.) of all layers included within the HP section 632 based on sensor information if needed. In some cases, throttling can be implemented in a portion or subset of the skippable layers of a particular section. For example, throttling of the HP section 632 of layers may include performing full or partial power collapse for a first subset of layers within the HP section 632, while a second subset of layers within the HP section 632 are not throttled or power collapsed.

Examples of sensor data obtained by the sensor hub 675 and used to control the skip connection layers (and/or used to perform power collapse of the respective power supply node connections within the hardware subsystem 670 that correspond to the skipped layers) can include distributed temperature sensor data obtained from one or more temperature sensors of the processing device or component thereof (e.g., including on-chip temperature sensors and/or on-printed-circuit-board temperature sensors, etc.), and/or obtained from one or more temperature sensors corresponding to a nearby (e.g., surrounding, ambient, etc.) environment of the processing device. For example, in some cases throttling of one or more skippable layers of the neural network can be performed based at least in part on the location and/or proximity of the particular skippable layers (e.g., the location and/or proximity of the on-chip hardware computing resources implementing the particular skippable layers) to the location where a thermal event occurs.

In another example, sensor data obtained by the sensor hub 675 and used to control the skip connection layers for power collapse within the hardware subsystem 670 can include fuel gauge sensor data corresponding to a battery of the device, for example indicative of a remaining state of charge, a remaining stored energy, a current battery voltage or output current, etc. In one illustrative example, the battery level falling below a first threshold can trigger a first group of skip connections to be used to skip a first group of skip layers (e.g., and power collapse can be performed in the hardware subsystem, 670 to stop or reduce the electrical power supply delivered to the processing hardware elements for the now skipped layers). In some cases, the battery level falling below a second threshold can further trigger a second group of skip connections to be used to additionally skip a second group of skip layers, etc.

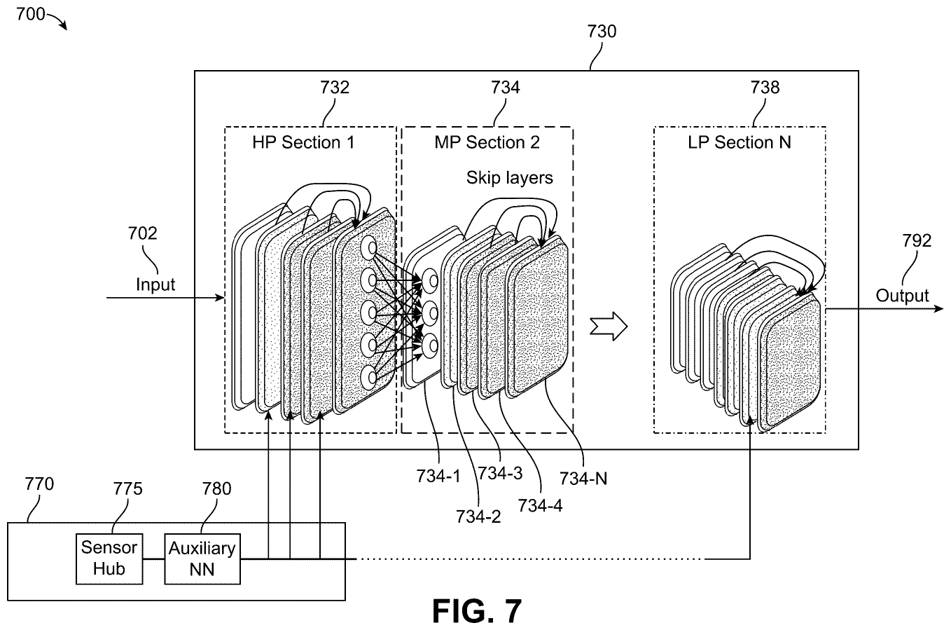

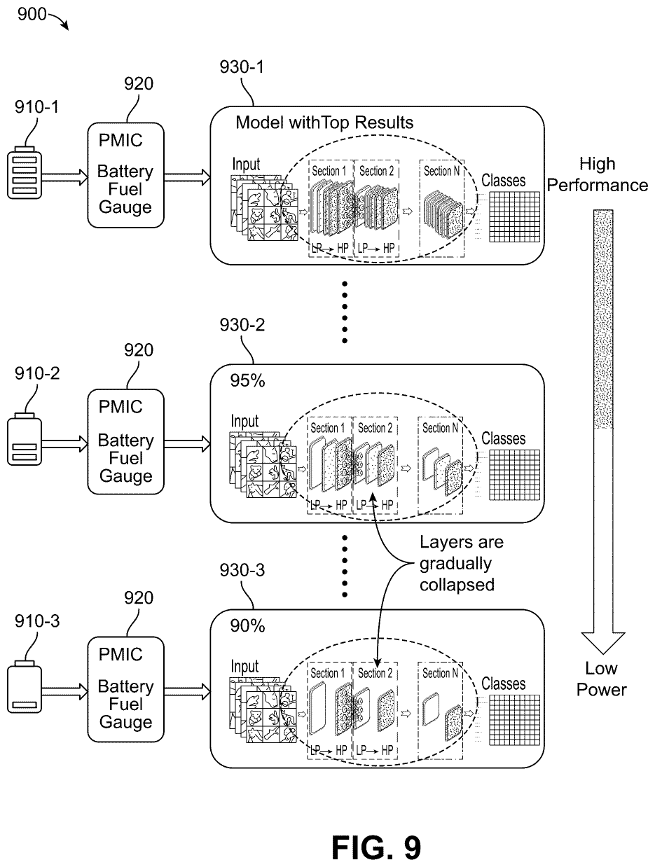

For example, FIG. 9 is a diagram illustrating an example of on-the-fly power collapse 900 performed for one or more skip connections and/or skippable layer portions of a machine learning network architecture, where the power collapse is performed during inference by the machine learning network architecture and based on battery level or temperature sensor data inputs. In some aspects, the power collapse 900 can be performed based on respective configurations of skip connection activations/deactivations to cause corresponding changes in the throttling or performance of one or more layers or neurons of a NN model architecture. The respective configurations of skip connection activations/deactivations can comprise different combinations of an activated state or deactivated state for the respective skip connections implemented by the NN model being adaptively adjusted, reconfigured, throttled, etc., during the on-the-fly power collapse process 900 of FIG. 9. In some examples, the different respective configurations of skip connection activations and deactivations can be determined based on, and/or may correspond to, different respective sensor input states (e.g., associated with a sensor hub such as the sensor hub 675 of FIGS. 6, 775 of FIG. 7, etc.).

For example, the different respective sensor input states can correspond to different values of one or more sensor inputs or sensor measurements. In some cases, the different sensor input states may correspond to comparisons of sensor input or measurement values to one or more configured thresholds. For example, a first sensor input state 910-1 of FIG. 9 can correspond to a PMIC 920 determining that a battery level state of charge is above a first threshold value (e.g., such as above an 80% state of charge, etc.).

A second sensor input state 910-2 can correspond to the PMIC 920 determining that the battery level state of charge is below the first threshold value (e.g., such as below 80%) associated with the first sensor input state 910-1. In some aspects, the second sensor input state 910-2 can correspond to the PMIC 920 determining that the battery level state of charge is below the first threshold value and is above a second threshold value, where the second threshold value is less than the first threshold value (e.g., determining that the battery level state of charge is between the second threshold and the first threshold). For example, the second sensor input state 910-2 can correspond to the PMIC 920 determining that the battery level state of charge is less than 80% and greater than 30%, etc.

A third sensor input state 910-3 can correspond to the PMIC 920 determining that the battery level state of charge is below the second threshold value (e.g., such as below 30%) associated with the second sensor input state 910-2. In some aspects, the third sensor input state 910-3 can correspond to the PMIC 920 determining that the battery level state of charge is below the second threshold value and is above a third threshold value, where the third threshold value is less than the second threshold value (e.g., determining that the battery level state of charge is between the third threshold and the second threshold), or may correspond to determining that the battery level is below the second threshold.

The different sensor input states 910-1, 910-2, 910-3, . . . , etc. can correspond to different combinations of one or more sensors and corresponding one or more threshold value comparisons for each of the one or more sensors. Different sensor input states can cause the hardware subsystem 670 to apply different respective configurations or combinations of skip connection activations and deactivations to power collapse the NN model architecture to implement different reconfigurations for adaptive throttling of model inference performance, etc., in response to the adapting conditions indicated by the changing sensor state values. For example, the underlying NN model for the power collapse process 900 of FIG. 9 may be the same as or similar to the machine learning network 630 of FIGS. 6, 730 of FIG. 7, etc.

The first sensor state 910-1 detected at the PMIC 920 can cause a hardware subsystem to open or close switches within one or more power supply nodes (e.g., 670 of FIG. 6, etc.) to apply a first configuration of skip connection activations/deactivations determined in response to the first sensor state 910-1. The first configuration of skip connection activations/deactivations from performing the power collapse can correspond to opening the power supply node switch connection to cut or reduce electrical power delivery to each skip connection set as active (e.g., used) according to the configuration. Performing the power collapse indicated by the activated skip connections in response to the first sensor state 910-1 can correspond to implementing a first model architecture configuration 930-1 of the NN model (e.g., such as 630 of FIGS. 6, 730 of FIG. 7, etc.).

The second sensor state 910-2 detected at the PMIC 920 can cause the hardware subsystem to open or close switches within one or more power supply nodes (e.g., 670 of FIG. 6, etc.) to apply a second configuration of skip connection activations/deactivations determined in response to the second sensor state 910-2. The second configuration of skip connection activations/deactivations from performing the power collapse can correspond to opening the power supply node switch connection to cut or reduce electrical power delivery to each skip connection set as active (e.g., used) according to the configuration. Performing the power collapse indicated by the activated skip connections in response to the second sensor state 910-2 can correspond to implementing a second model architecture configuration 930-2 of the NN model (e.g., such as 630 of FIGS. 6, 730 of FIG. 7, etc.). In some aspects, the second configuration of skip connection activations and deactivations can include the first configuration of skip connection activations and deactivations (e.g., the first sensor state 910-1 causes a first set of skip connections to be activated and power collapsed, and the second sensor state 910-2 causes one or more additional skip connections to be activated and power collapsed while also keeping the first set of skip connections active). In some examples, the second configuration of skip connection activations/deactivations may deactivate one or more skip connections that were previously activated in the first configuration associated with sensor state 910-1.

The third sensor state 910-3 detected at the PMIC 920 can cause the hardware subsystem to open or close switches within one or more power supply nodes (e.g., 670 of FIG. 6, etc.) to apply a third configuration of skip connection activations/deactivations determined in response to the third sensor state 910-3. The third configuration of skip connection activations and deactivations from performing the power collapse can correspond to opening the power supply node switch connection to cut or reduce electrical power delivery to each skip connection set as active (e.g., used) according to the configuration. Performing the power collapse indicated by the activated skip connections in response to the third sensor state 910-3 can correspond to implementing a third first model architecture configuration 930-1 of the NN model (e.g., such as 630 of FIGS. 6, 730 of FIG. 7, etc.). In some aspects, the third configuration of skip connection activations and deactivations can include the first configuration and the second configuration of skip connection activations and deactivations (e.g., the first sensor state 910-1 causes a first set of skip connections to be activated and power collapsed, and the second sensor state 910-2 causes one or more additional skip connections to be activated and power collapsed while also keeping the first set of skip connections active, and the third sensor state 910-3 causes a still further set of one or more additional skip connections to be activated and power collapsed). In some examples, the third configuration of skip connection activations and deactivations associated with sensor state 910-3 may deactivate one or more skip connections that were previously activated in the first configuration associated with sensor state 910-1 and/or that were previously activated in the second configuration associated with sensor state 910-2, etc.

In another example, sensor data obtained by the sensor hub 675 and used to control the skip connection layers for power collapse within the hardware subsystem 670 can include noise level information indicated by a digital microphone of the device, etc. The sensor data may include audio data or representations of speech, and/or audio data or representations of environmental noise nearby to the processing device, etc. In some cases, the sensor data may be included, at least in part, in one or more of the inputs 602 to the machine learning network 630. For example, the machine learning network 630 can be a keyword spotting (KWS) or keyword detection audio processing NN model, and the microphone or other audio sensor data may be included in both the input 602 to the NN model 630 itself as well as within an input provided to the sensor hub 675 and used to determine throttling and skipping or scaling of portions of the NN model 630 architecture. For example, audio data indicative of a possible (e.g., moderate confidence, confidence above a threshold, etc.) can in some cases be used to trigger or cause the sensor hub 675 and hardware subsystem 670 to scale up the model performance by deactivating one or more skip connections, where deactivating one or more skip connection corresponds to activating one or more layers or layer sections of the NN model 630 architecture that were previously powered off.

The sensor-based control of the skip connections and skip layers can be configured based on threshold values of the sensor data, based on threshold rates of change of the sensor data; patterns or trends over time in the sensor data; combinations of multiple different sensor data measurements; etc. In some aspects, sensor data obtained by the sensor hub 675 and used to control the skip connection layers for power collapse within the hardware subsystem 670 can include directly measured sensor data obtained by one or more sensors associated with the sensor hub 675, and/or can include derived or processed sensor data determined based on inputs comprising one or more directly measure sensor data values, etc.

In some aspects, the sensor data can include at least a portion of the input data provided to the NN model during the inference processing flow. For example, the NN model may be configured to perform wake-up detection or keyword speech detection processing, which uses the device microphone sensor data as input to the model. In some cases, the device microphone sensor data can be used to control and configure the skip connections and skip layers of the NN speech detection model. For example, if the microphone sensor data includes only sounds below a threshold level (or an average loudness over a time window is below a threshold, etc.), the skip connections can be controlled or configured to shut down high-performance (HP) portions of the NN model layers. An increase in loudness or sudden spikes in noise, etc., can be used to deactivate the skip connections and turn on the higher performance groups of layers of the NN model, etc.

In another example, the skip connections and skip layers can be controlled based on an ambient light sensor and/or image sensor (e.g., camera or video data, etc.) of the processing device implementing the machine learning architecture 630. For example, DNN adaptation can be implemented by controlling skip connections and skip layers based on at least one of: ambient light levels or ambient light conditions, quality of image information can be used to control a number of skipped layers powered down of an image-processing NN model, contrast information or local brightness information for various pixel regions of the image sensor data (among various other image parameters), etc. In some aspects, the sensor hub 675 and/or hardware subsystem 6760 can be configured to use sensor data to determine adaptive configuration adjustments for the architecture of the machine learning network 630, where the adaptive configuration adjustments correspond to activating or deactivating various respective skip connections or skippable layers (e.g., layers having one or more skip connections, etc.) to thereby scale the size or dimensionality (e.g., number of layers, width of layers, etc.,) of the image processing NN up or down.

In some aspects, the skip connections of the machine learning network 630 can be controlled based on the sensor data obtained by the sensor hub 675 to vary the activation and power state of the respective internal layers that are between the respective input and output layers of each section of one or more sections 632, 634, . . . , 638 segmented from the plurality of layers of the machine learning network 630. In some aspects, the sensor hub 675 can be configured to dynamically and actively control one or more of an accuracy level or performance characteristic associated with one or more machine learning layers or sections thereof include in the machine learning network 630. In some cases, the performance characteristic can be a power dissipation or thermal performance of the hardware elements allocated by the processing device to implement inference processing operations corresponding to particular layers or neurons of the machine learning network 630 architecture. In one illustrative example, the sensor hub 675 can use the hardware layer 670 to control a particular layer with a skip connection from a power control node or PMIC of the hardware layer 670, to cause the hardware processing elements for the particular layer to be powered down (e.g., turned off) or to cause the hardware processing elements for the particular layer to be powered up (e.g., turned on). In some aspects, power control for one or more layers can be controlled directly on the sensor data obtained by the device or associated with the sensor hub 675. In one illustrative example, the systems and techniques can be implemented in hardware or analog-based circuitry drive control (e.g., direct control of skip layers and power supply lines that is not performed by software logic).

In some aspects, based on using the skip connections and skip layers to activate and deactivate different groups of layers and/or different sections of the NN model architecture 630, model scaling can be implemented without memory interaction by the processing device performing the inference operations using the NN model 630, before, during, and/or after implementing the reconfiguration based on sensor data. In some aspects, the device storage needs for the NN model 630 can be reduced, as the model scaling can be performed using only a single model for storage (e.g., performed without storing, accessing, and loading multiple copies of a DNN each with different sizes). The skip connections and skip layers can be used to avoid static memory changes, layer connection changes, or different weights in the NN model architecture, by obtaining the different model scaling configurations from different combinations of activated and deactivated layers or layer groups (with each layer or layer group being activated by not using the skip connection, and/or being deactivated by using the skip connection). Deactivated layers can be skipped without being powered down (e.g., skip connection is implemented logically, power supply connection is kept active) and/or deactivated layers can be skipped by being powered down (e.g., skip connection is implemented physically, power supply connection is cut or turned off for the deactivated skip layers/groups). In another example, one or more deactivated layers can be implemented using various mux operations of the outputs of different internal layers of the NN model architecture, etc. For example, the outputs of different layers of a NN model architecture can be provided to a multiplexer or other mux module. A first mux configuration can correspond to not deactivating (e.g., not skipping) one or more skip layers that are associated with a skip connection. A second mux configuration can correspond to deactivating (e.g., skipping) the one or more skip layers that are associated with the skip connection, based on a different combination (e.g., mux) of the respective outputs of the different NN layers when using the second mux configuration.

In some examples, a layer ID or layer index can be mapped to priority rules, priority levels, or priority conditions for the adaptive throttling and/or reconfiguration of the machine learning architecture 630, skip connections, and/or power collapse switching states (e.g., on/off switch state from the power supply node to the respective power supply line for processing elements corresponding to each skippable layer or layer section, etc.). For example, the sensor-based control of skip connections can be implemented based on indexing the priority of different layers to be dropped or kept based on different sensor data inputs, values, and/or thresholds, etc. In some aspects, the priority of layers to be dropped or kept can be indexed and implemented per sensor input or various combinations of multiple sensor inputs from the plurality of sensors. In some cases, priority indexing can be used to implement a lookup table that can correspond to a low-level hardware implementation or analog logic implementation of the sensor hub and power collapse in the hardware subsystem 670. In some cases, a layer index for layers of the NN model 630 can be used with one or more of a battery level sensor measurement, and/or a priority index can be used with one or more of a thermal event identification or sensor input.

In some aspects, the control of the power collapse and reconfiguration of the NN model 630 architecture using the skip connections can be provide by a low-level hardware logic (e.g., analog or circuit logic, etc.), as noted above. In some aspects, the control of the power collapse and reconfiguration of the NN model 630 architecture can be at least in part provided as software-based control. For example, software-based control can be provided to interpret the sensor data and generate corresponding commands to use or not use skip connections and skip layers, and/or to power on or power off the different groups of one or more skip connection layers.

In one illustrative example, the systems and techniques can use an auxiliary neural network configured with one or more learnable thresholds to dynamically control the collapsing of internal skip layers within a larger NN model architecture of a model being used to perform inference. For example, the auxiliary neural network can be used to implement learnable thresholds to dynamically control the collapsing of internal skip layers for the NN model 630 of FIG. 6.

For example, FIG. 7 is a block diagram illustrating an example of a machine learning system 700 which can be based on the machine learning system 600 of FIG. 6. In some examples, the machine learning system 700 can be the same as the machine learning system 600, with the addition of an auxiliary neural network 780 that can be used to process sensor data obtained from a sensor hub 775 and/or hardware subsystem 770 (e.g., which can be the same as or similar to sensor hub 675 and hardware subsystem 670, respectively). The auxiliary neural network 780 of FIG. 7 can be configured to implement one or more learnable thresholds to dynamically control the collapsing of internal skip layers within a larger NN model architecture of the machine learning network 730 being used to perform inference for one or more inputs of data 702 (e.g., the same as or similar to input data 602 of FIG. 6).

In some aspects, the machine learning system 700 includes a machine learning network 730 architecture including a plurality of layers segmented into one or more sections (e.g., 732, 734, 738 which may be the same as or similar to 632, 634, 638 of FIG. 6) that can be dynamically adjusted and/or reconfigured to provide different accuracy and/or power dissipation based on one or more learnable thresholds implemented by the auxiliary neural network 780, in accordance with some examples. In some examples, the auxiliary neural network 780 can be implemented between the sensor hub 775 and the power supply connections or switches of power supply nodes corresponding to hardware computing resources or processing elements for the various respective layers included in the sections 732, 734, 738, etc., of the primary neural network 730 performing the inference to generate outputs 792 from inputs 702. In some aspects, input 702 can be the same as or similar to input 602; output 792 can be the same as or similar to output 692; input layer 734-1 can be the same as or similar to input layer 634-1; output layer 734-N can be the same as or similar to the output layer 634-N; and the intermediate layers 734-2, 734-3, 734-4 can respectively be the same as or similar to the intermediate layers 634-2, 634-3, 634-4; etc. First section 732 can be a high-performance (HP) section the same as or similar to first section 632; second section 734 can be a moderate performance (MP) section the same as or similar to second section 634; N^{th} section 738 can be a low-performance (LP) section the same as or similar to the N^{th} section 638; etc.

In one illustrative example, the auxiliary neural network 780 can be referred to as a power meter neural network, for example in cases where the auxiliary neural network 780 implements one or more learnable thresholds to dynamically control collapsing internal skip layers based on the power meter neural network 780 monitoring battery usage or sensor outputs per app per layer of the model 730. In some aspects, the power meter neural network 780 may separately be configured to assist with selection or identifying (e.g., determining) the layers with large power consumptions, and can deactivate or skip layers with large power consumptions to help improve metrics together. In some aspects, the power meter neural network 780 can be provided between the sensor hub 775 and the power control lines (e.g.,, within hardware subsystem 770) to each skip connection layer or group of skip connection layers. The power meter neural network 780 can receive sensor data as input from the sensor hub 775, and may implement a learnable threshold to dynamically control collapsing internal skip layers. In some examples, the power meter neural network 780 can be used to monitor battery usage and/or sensor outputs per application per layer, etc. In some examples, the power meter neural network 780 can be used to determine or select the layers of the NN model 730 with relatively high or large power consumption, and to subsequently throttle, skip, power down, etc., the identified layers with the high power consumption. In some examples, the learnable threshold(s) implemented by the power meter neural network 780 for controlling the skip connection layers and corresponding power supply lines can be learned threshold values based on performance metrics of the NN model 730 inference running on the processing device to predict the outputs 792 from the inputs 702. For example, the performance metrics can include throughput, user experience, SNR level, signal quality, etc.

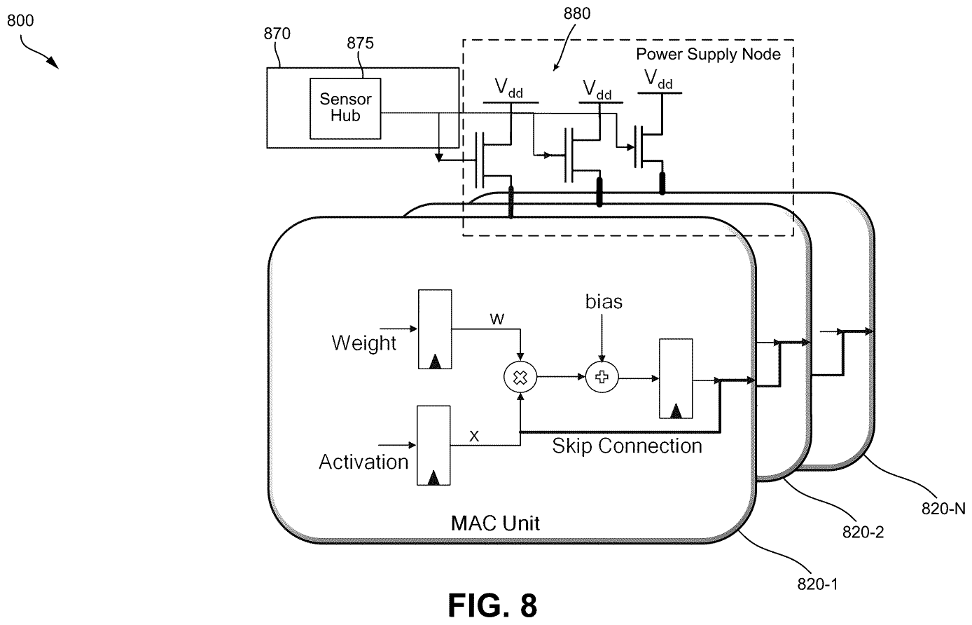

FIG. 8 is a diagram illustrating an example of a plurality of multiply-accumulate (MAC) units 800 that can be used as the processing elements associated with implementing respective neurons, layers, and/or portions of a neural network architecture (e.g., such as architecture 6730 of FIGS. 6, 730 of FIG. 7, 9301-, 930-2, and/or 930-3 of FIG. 9; etc.)

In some aspects, the plurality of MAC units 800 includes a plurality of MAC units that are implemented as individually controlled power collapsable multiply-accumulate (MAC) units that can be used to implement one or more skip layers and/or skip connections for a machine learning network architecture, in accordance with some examples. In some cases, the plurality of MAC units 800 includes the first MAC unit 820-1, a second MAC unit 820-2, . . . , and an N^{th} MAC unit 820-N. The MAC units 820-1, 820-2, 820-N may be the same as or similar to one another, and each respective MAC unit may individually be connected to one or more switches of a power supply node 880 configured to provide electrical power to at least a portion of a respective MAC unit based on closing the corresponding power supply switch for the respective MAC unit, and configured to not provide electrical power to the at least a portion of the respective MAC unit based on opening the corresponding power supply switch in the power supply node 880.

In some aspects, the power supply node 880 includes one or more switches for power supply delivery (or non-delivery, if the switch is opened) to each respective one of the plurality of individually controlled power collapsable MAC units 800. For example, the power supply node 880 can include a respective set of one or more power switches associated with connecting the first MAC unit 820-1 to a power/voltage source V_{dd}, a second respective set of one or more power switches associated with connecting the second MAC unit 820-2 to a power/voltage source V_{dd}, . . . , and an N^{th} respective set of one or more power switches associated with connecting the N^{th} MAC unit 820-N to a power/voltage source V_{dd}.

The power supply node 880 can be associated with a hardware subsystem 870 that can be the same as or similar to the hardware subsystem 670 of FIGS. 6 and/or 770 of FIG. 7. In some cases, the power supply node 880 includes the plurality of switches for the plurality of MAC units 820-1, 820-2, 820-N where the switches are opened or closed based on one or more outputs or sensor data streams associated with the sensor hub 875 of the hardware subsystem 870. The sensor hub 875 may be the same as or similar to the sensor hub 675 of FIGS. 6, 775 of FIG. 7, etc. In some cases, the skip connections and skip layers associated with the sensor-based control for on-the-fly throttling and scaling of the NN model architecture can be implemented based on individually controlled power collapsible multiply-accumulate (MAC) units 820-1, 820-2, . . . , 820-N in the skip layers. In some aspects, the systems and techniques can utilize the same control and power collapse logic applied to individual MAC units and/or applied to layer-based and/or channel-based groups of multiple MAC units of the NN architecture.

Each MAC unit (e.g., such as the first MAC unit 820-1, shown in FIG. 8) can include an input accumulator for a weight value W, and an input accumulator for an activation value x. The accumulated values W and x can be multiplied by a multiply operator of the MAC unit 820-1, with the multiplied output being summed with a bias value and provided to an output accumulator operator of the MAC unit 820-1. In some aspects, individually controlled power collapsible MAC units in skip layers may be implemented to include a skip connection between the output path of the activation accumulation signal x, and the output of the final accumulator operator of the MAC unit 820-1.

For example, activating or using the skip connection in the MAC unit 820-1 can cause the MAC unit 820-1 to skip performing (e.g., not perform) the multiply-accumulate operation between the activation, weight, and bias values as described above. Based on the skip connection being tied between the accumulated activation signal, x, within the MAC unit 820-1 and the final output path from the MAC unit 820-1, the MAC unit 820-1 may be power collapsed by opening the corresponding switch(es) within the power supply node 880 that provide electrical power to a first portion of the MAC unit 820-1. A second switch may remain closed to provide power from power supply node 880 to a second portion of the MAC unit 820-1, so that the activation signal accumulated as x can travel on the skip connection to be output from the MAC unit 820-1 and on to the next MAC unit in the processing path. In some aspects, the skip connection and preservation of the activation signal x across multiple MAC units that are configured for power collapse by opening respective switches within power supply node 880- can be implemented by providing dedicated power supply lines for preserving the activation signal across MAC units 800 during power collapse.

In one illustrative example, power collapse of MAC units 820-01, 820-2, . . . , 820-N can be performed corresponding to use of a skip connection or skip layer, as noted above. During power collapse, to transfer the activation signal x from the current layer (e.g.,, layer associated with a given MAC unit 820-1, etc.) to the next layer, a local buffer for the activation signal (e.g., the accumulator of the activation, noted above) can remain electrically powered, using a separate power supply line and/or a dedicated power supply line that is not switchable off and on by the power supply node 880 during or for power collapse operations. In some aspects, because the outputs of two registers are shorted during the power collapse for a MAC unit 820-1, an IC implementation of the MAC unit 820-1, etc., can correspond to these two registers having a hi-Z state.

In some examples, the systems and techniques can be used to provide spatially aware layer-based throttling and/or spatially aware channel-based throttling. For example, in some aspects each respective layer of a plurality of layers of a machine learning model (e.g., 630 of FIGS. 6, 730 of FIG. 7, 930-1, 930-2, 930-3 of FIG. 9, etc.) may be associated with a respective set of a plurality of MAC units 800 for implementing the respective layer in the processing element hardware of the device running the machine learning model. In some cases, the plurality of MAC units 800 of FIG. 8 can be a respective plurality of individually controlled power collapsible MAC units in a particular skip layer (e.g., skippable layer associated with one or more skip connections) of the machine learning model. In some aspects, each layer of the plurality of layers of the machine learning model can be associated with its own corresponding temperature sensor (e.g. a Tⱼ or junction temperature sensor). For example, the plurality of MAC units 800 of FIG. 8 can comprise one layer and can be associated with a dedicated Tⱼ sensor. In some examples, a group of layers can share one Tⱼ sensor (e.g., a single Tⱼ sensor can provide temperature sensor data corresponding to multiple sets of MAC units, each set comprising the plurality of MAC units 800 for a single layer of the machine learning model, etc.). In some aspects, the plurality of MAC units 800 for a single layer of the model can have a corresponding (e.g., respective) data flip-flop (DFF). For example, each layer can have a local DFF for the plurality of MAC units 800 and/or for each respective MAC unit included in the plurality of MAC units 800 for each respective layer of the plurality of skippable layers of the machine learning model. In some cases, the skippable layers implemented according to the plurality of MAC units 800 of FIG. 8 for each layer may be throttled during inference by the larger machine learning model that includes the skippable layers. For example, a skippable layer implemented according to the plurality of MAC units 800 can be throttled while the whole DNN remains fully operational. In some aspects, a portion of weights can be used similar to the spatially aware layer or channel throttling, with gradient diminishes controlled by backpropagation.

In some examples, training can be performed based on iterative freezing to obtain trained information (e.g., learnable thresholds for the auxiliary neural network 780 of FIG. 7, etc.) mapping between different sensor states, sensor conditions, sensor values, etc., and different throttling configurations that activate or deactivate respective portions of the NN model architecture using the corresponding skip connections (or not using the corresponding skip connections, in examples where a portion of the NN model architecture is being activated). For example, the iterative training and learnable threshold(s) implemented by the auxiliary neural network 780 of FIG. 7 can be used to maintain accuracy to an optimum level while performing the power collapse and dynamic throttling and/or reconfiguration of the neural network 730 architecture, etc.

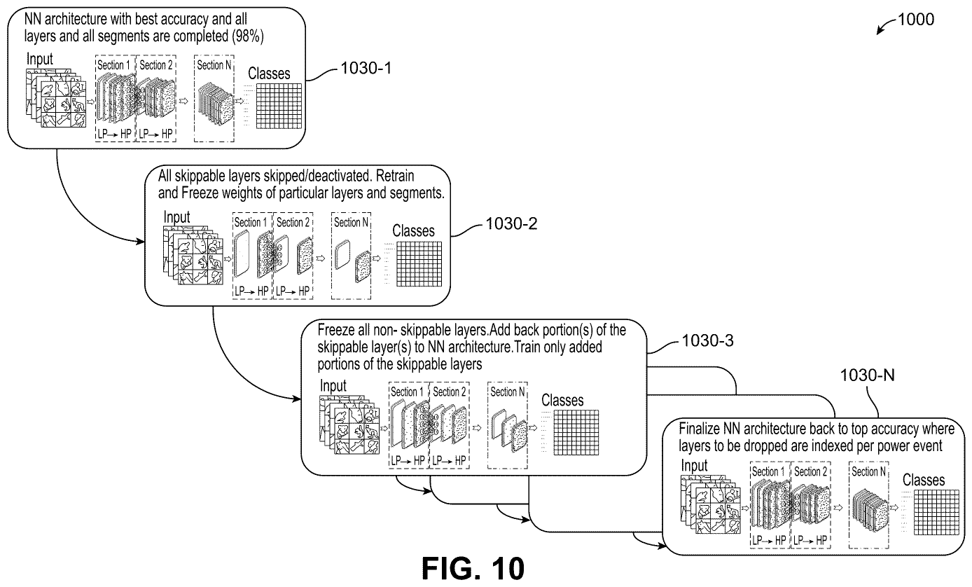

For example, FIG. 10 is a diagram illustrating an example of an iterative training process flow 1000 that may be implemented based on iteratively freezing different layers and/or skip connections of the machine learning network architecture, in accordance with some examples. In some aspects, the iterative training 1000 may be performed for the machine learning system 600 of FIG. 6 (e.g., including the NN model 630) and/or the machine learning system 700 of FIG. 7 (e.g., including the NN model 730 and the auxiliary NN model 780, etc.). In some cases, the iterative training process 1000 can be performed for one or more of the neural network model associated with the configuration(s) 930-1, 930-2, and/or 930-3 of FIG. 9, etc.

For example, the iterative training and freezing process can be implemented for optimizing the learnable threshold(s) of an auxiliary neural network configured to implement power collapse, throttling, and/or skip connection activation and deactivation according to input sensor data obtained from one or more sensors of a processing device implement the auxiliary neural network and/or the primary neural network model that is throttled based on the learnable threshold from the auxiliary NN model. In a first stage 1030-1 of the iterative training and freezing process 1000, training is performed to obtain an initial or baseline training of the NN model with the best accuracy. For example, the first stage 1030-1 can comprise training the NN model without using the skip connections (e.g., training the full architecture of the NN model, with no skip connections used and/or with no skippable layers being skipped). The initial training stage 1030-1 can be configured for a particular number of layers in multiple sections, and/or a particular number of neurons, channels, etc. In some aspects, the initial training stage 1030-1 corresponds to training the NN model in an unthrottled configuration, where no layers are power collapsed and no skip connections or skippable layers are used. In some examples, the initial training stage 1030-1 can be performed to train the full NN model architecture until one or more target thresholds or configured performance levels are met by the trained NN model. For example, initial training of the full NN model architecture in the initial stage 1030-1 may be performed until 98% accuracy is achieved with 20 layers and 50 neurons with 5 seconds in average, for example (e.g., among various other training target, configurations, thresholds, etc.).

The baseline trained full NN model architecture can then be provided to a plurality of iterative training and freezing stages that are implemented based on freezing different sets or combinations of the skippable layers. For example, in stage 1030-1, the NN model is trained with no layers frozen (e.g., out of the plurality of NN model layers comprising a subset of skippable layers and a subset of non-skippable layers).

In stage 1030-2, the trained NN model can be trimmed to different levels by prioritizing power levels and performance and/or based on configured accuracy levels for the various training stages. In some aspects, at stage 1030-2, the trained NN model is modified and reconfigured by deactivating (e.g., freezing) all of the skippable layers. The architecture of the NN model is fixed according to the results of the initial training stage 1030-1 (e.g., for the non-skippable layers), and the skippable layers are skipped by being frozen in the NN model.

After selecting the subset of skippable layers to be frozen during a particular iterative training stage (e.g., such as the first iterative training stage 1030-2, etc.), the reduced NN model architecture is re-trained with only the remaining, non-frozen layers being trained. For example, the iterative training and freezing process may be performed to trim the NN model network to different levels that prioritize different power levels, accuracy levels, etc., which may be mapped to different sensor conditions according to the learnable thresholds of an auxiliary neural network model. In some examples, the NN network trimming may correspond to trimming (e.g., removing, reducing, etc.) 25% of the NN architecture structure to reduce the power consumption of the NN model during inference by a corresponding amount (e.g., approximately 25%, etc.). In some cases, large reductions or certain reductions that remove various portions of the NN model architecture may have larger negative impacts that reduce performance or accuracy. The iterative training process 1000 can be repeated for a plurality of iterative training steps or stages, each using a different reduced architecture for the NN model, to thereby determine the smaller network sizes with the best performance or accuracy.

In some examples, the reduced NN model is generated by removing 25% of the structure of the network, and repeating training with the 25% reduced architecture to obtain the best accuracy performance of the 25% reduced, smaller network. After training the reduced architecture network, the layers of the reduced architecture can be frozen, and portions of the previously removed layers (e.g., portions of the 25% reduction comprising skippable layers of the NN model architecture) can be added back to the model. For example, 5% of the removed layers can be added back to the trained and frozen 25% reduced NN architecture, and training may again be repeated, for the new layers only, to obtain the best accuracy performance reduced architecture NN model at the 20% reduction level. The process noted above can be repeated to obtain the best accuracy performance reduced architecture NN model at various reduction levels that are between the initial reduction (e.g., corresponding to stage 1030-2, when the percentage reduction corresponds to the percentage of skippable layers out of the plurality of layers in the NN model full architecture) and the no reduction level (e.g., 0% reduction) obtained when training the full model architecture in the initial stage 1030-1.

In one illustrative example, initial training stage 1030-1 freezes no layers and removes no skippable layers, and is performed to obtain the best performing (e.g., best accuracy, best power consumption, etc.) trained NN model at the 0% reduction level.

The first iterative training stage 1030-2 can be performed by removing the maximum number of layers possible from the NN model architecture (e.g., removing all skippable layers), and performing re-training to obtain the best performing trained NN model at the maximum reduction level corresponding to using all skip connections and/or skippable layers. The second iterative training stage 1030-3 can be performed to obtain the best performing trained NN model at a reduction level that is less than the maximum reduction level, by an amount corresponding to the number of removed layers that are added back to the trained reduced NN architecture output after stage 1030-2. Re-training can be performed at the second iterative training stage 1030-3, with the previously trained layers from stage 1030-2 frozen so that only the layers being added back in at the second iterative training stage 1030-3 are learning.

Subsequent iterative training stages (e.g., after second iterative training stage 1030-3, etc.) can be performed to repeat the process of adding back one or more previously removed layers and re-training with only the added layers learning. In some aspects, iterative training stage 1030-3 can be repeated for a plurality of different reduced NN model architecture configurations. The power dissipation of the respective layers during re-training for each reduced architecture configuration can be analyzed and indexed to performance characteristics, and the iterative training process repeated until the best performance is reached for a configured threshold or training goal (e.g., loss, reward, etc.). In one illustrative example, a plurality of subsequent iterative training stages can be performed after the second iterative training stage 1030-3. In some aspects, the iterative training process 1000 can be ended at a final stage 1030-N, where the NN model architecture can be finalized back to top accuracy and with mapping information and/or learnable threshold information indicative of the layers to be dropped (e.g., skipped, power collapsed, etc.) indexed to per power event information.

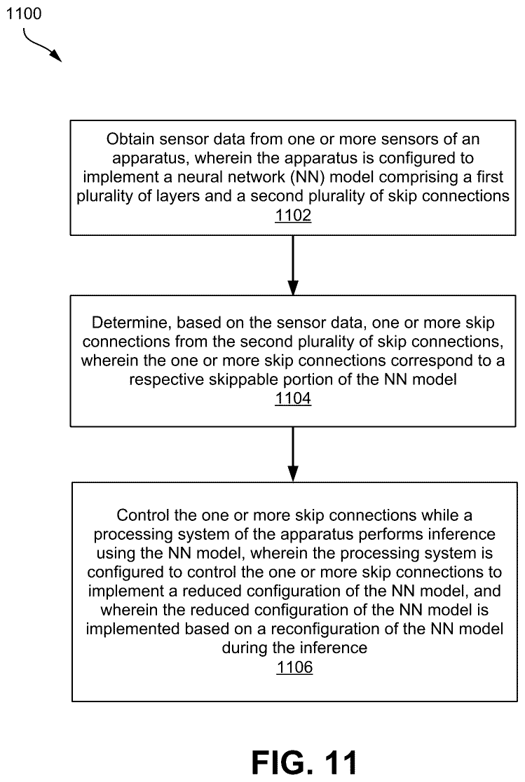

FIG. 11 is a flowchart diagram illustrating an example of a process 1100. Although the example process 1100 depicts a particular sequence of operations, the sequence may be altered without departing from the scope of the present disclosure. For example, some of the operations depicted may be performed in parallel or in a different sequence that does not materially affect the function of the process 1100. In other examples, different components of an example device or system that implements the process 1100 may perform functions at substantially the same time or in a specific sequence.

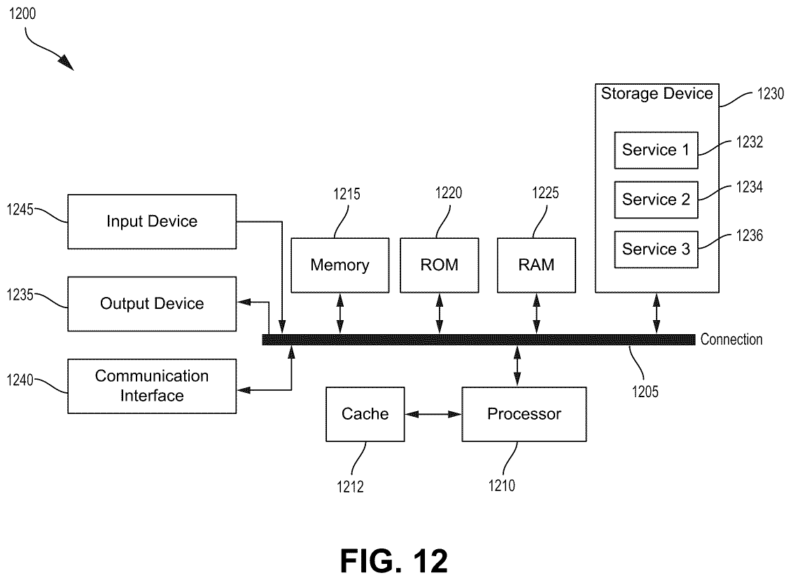

In some examples, the process 1100 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. The operations of the process 1100 may be implemented as software components that are executed and run on one or more processors (e.g., processor 1210 of FIG. 12 or other processor(s)). In some examples, the process 1100 can be performed by a machine learning network, including any of the machine learning networks and/or neural networks described herein, etc. In some aspects, the process 1100 can be performed by a UE, smartphone, mobile computing device, user computing device, etc. The process 1100 may be performed by an apparatus that may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1100 may be implemented as software components that are executed and run on one or more processors (e.g., processor 1210 of FIG. 12, and/or other processor(s)).

At block 1102, the apparatus (or component thereof) can obtain sensor data from one or more sensors of the apparatus, wherein the apparatus is configured to implement a neural network (NN) model comprising a plurality of layers and a plurality of skip connections. For example, the sensor data can be obtained from one or sensors included in the sensor hub 675 of FIGS. 6, 775 of FIGS. 7, 875 of FIGS. 8, 920 of FIG. 9, etc. In some cases, the NN model can correspond to any of the NN and/or machine learning models of FIGS. 1-10. In some examples, the plurality of skip connections can correspond to one or more of the skip connections and/or corresponding skippable layers of FIGS. 6-10.

In some cases, to obtain the sensor data, the processing system is configured to obtain the sensor data after initiating one or more inference operations corresponding to the inference using the NN model. In some cases, the processing system can be configured to implement the reduced configuration of the NN model without terminating at least one of the one or more inference operations or the inference.

In some examples, the sensor data is associated with performance of the inference by the processing system. In some cases, the processing system is configured to obtain the sensor data from the one or more sensors during the inference. In some cases, the sensor data is indicative of at least one of: a temperature of one or more components of the processing system associated with the processing system performing the inference using the NN model, or a power consumption associated with the processing system performing the inference using the NN model. In some examples, at least a portion of the sensor data is included in one or more respective inputs to the NN model during the inference. For example, at least a portion of the sensor data can be included in the input 602 to the NN model 630 of FIG. 6, can be included in the input 702 to the NN model 730 of FIG. 7, etc.

At block 1104, the apparatus (or component thereof) can determine, based on the sensor data, one or more skip connections from the plurality of skip connections, wherein the one or more skip connections correspond to a respective skippable portion of the NN model. For example, the one or more skip connections can correspond to a skippable portion of the NN model such as the HP section 632, MP section 634, and/or LP section 638 of the NN model 630 of FIG. 6. In some examples, the one or more skip connections can correspond to a skippable portion of the NN model such as the HP section 732, MP section 734, and/or LP section 738 of the NN model 730 of FIG. 7.

In some cases, to control the one or more skip connections, the processing system can be configured to open a respective power supply switch connected between the one or more skip connections and a power source of the apparatus, wherein opening the respective power supply switch deactivates at least a portion of the one or more skip connections and reconfigures the NN model to deactivate the respective skippable portion. In some cases, to control the one or more skip connections, the processing system can be configured to close a respective power supply switch connected between the one or more skip connections and a power source of the apparatus, wherein closing the respective power supply switch activates at least a portion of the one or more skip connections.

At block 1106, the apparatus (or component thereof) can control the one or more skip connections while the processing system performs inference using the NN model, wherein the processing system is configured to control the one or more skip connections to implement a reduced configuration of the NN model, and wherein the reduced configuration of the NN model is implemented based on a reconfiguration of the NN model during the inference.

In some examples, the reduced configuration of the NN model does not include the respective skippable portion. The processing system can be configured to initiate one or more inference operations using a first configuration of the NN model, where the first configuration includes the respective skippable portion of the NN model. The processing system can be configured to implement the reduced configuration of the NN model based on using the one or more skip connections to implement the reconfiguration of the NN model. For example, the processing system can be configured to implement the reduced configuration of the NN model after initiation of the one or more inference operations using the first configuration.

In some cases, to implement the reduced configuration of the NN model, the processing system can be configured to use the one or more skip connections to deactivate the respective skippable portion in the first configuration of the NN model. For example, in some cases the reduced configuration of the NN model comprises the first configuration with the respective skippable portion removed. In some cases, the one or more skip connections are not used in the first configuration of the NN model. In some examples, the one or more skip connections are used in the reduced configuration of the NN model. In some cases, using the one or more skip connections in the reduced configuration of the NN model causes the processing system to perform the inference without using the respective skippable portion of the NN model.

In some cases, to perform inference using the NN model, the processing system can be configured to implement a first configuration of the NN model based on a first sensor state determined using the one or more sensors. The processing system can implement the reduced configuration of the NN model based on a second sensor state determined based on the sensor data, where the sensor data is indicative of one or more configured changes from the first sensor state.

In some examples, the first configuration includes each respective layer of the plurality of layers, and the reduced configuration comprises the plurality of layers with one or more layers corresponding to the respective skippable portion deactivated. In some cases, the processing system can be configured to implement the first configuration of the NN model based on activating, for each respective layer of the plurality of layers, one or more processing elements of a plurality of processing elements of the apparatus. The processing system can implement the reduced configuration of the NN model based on deactivating the one or more processing elements corresponding to each skippable layer of one or more skippable layers included in the respective skippable portion of the NN model.

In some cases, to deactivate the one or more processing elements corresponding to each skippable layer, the processing system can be configured to control a power supply node of the apparatus to switch off power supply to the respective one or more processing elements previously activated for each skippable layer of the one or more skippable layers included in the respective skippable portion of the NN model.

In some cases, the processing system is configured to throttle the NN model during inference based on performing a power collapse of one or more layers corresponding to the respective skippable portion and included in the plurality of layers. In some examples, the one or more skip connections and the one or more layers corresponding to the respective skippable portion are implemented using only local buffers or local data flip-flops (DFFs). In some case, to perform the power collapse, the processing system is configured to open one or more power supply switches corresponding to each skip connection of the one or more skip connections, where opening the one or more power supply switches disconnects a power supply from the apparatus to a portion of the processing system configured to implement the one or more layers corresponding to the respective skippable portion of the NN model.

In some cases, to perform the power collapse, the processing system can be configured to preserve state information of one or more local buffers or local data flip-flops (DFFs) associated with an activation signal to the one or more skip connections or the one or more layers corresponding to the respective skippable portion.

In some examples, the processing system can be configured to process the sensor data using an auxiliary neural network implemented by the apparatus. For example, the auxiliary neural network can be the same as or similar to the auxiliary NN 780 of FIG. 7. In some cases, an output of the auxiliary neural network comprises a learnable threshold indicative of at least one of: the respective skippable portion of the NN model, or the one or more skip connections. In some examples, to control the one or more skip connections while the processing system performs the inference, the processing system can be configured to activate each respective skip connection of the one or more skip connections based on the output of the auxiliary neural network.

In some cases, the processing system can be configured to determine, using the auxiliary neural network and the sensor data, a selected subset of skip connections from the plurality of skip connections, where the selected subset of skip connections comprises the one or more skip connections. The processing system can control the selected subset of skip connections to perform a power collapse of one or more internal skip layers of the NN model, where the power collapse implements the reduced configuration of the NN model, and wherein the one or more internal skip layers comprise the respective skippable portion of the NN model.

FIG. 12 illustrates an example computing device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1200 are shown in electrical communication with each other using connection 1205, such as a bus. The example computing device architecture 1200 includes a processing unit (CPU or processor) 1210 and computing device connection 1205 that couples various computing device components including computing device memory 1215, such as read only memory (ROM) 1220 and random access memory (RAM) 1225, to processor 1210.

Computing device architecture 1200 can include a cache of high-speed memory connected directly with, in close proximity to, or integrated as part of processor 1210. Computing device architecture 1200 can copy data from memory 1215 and/or the storage device 1230 to cache 1212 for quick access by processor 1210. In this way, the cache can provide a performance boost that avoids processor 1210 delays while waiting for data. These and other modules can control or be configured to control processor 1210 to perform various actions. Other computing device memory 1215 may be available for use as well. Memory 1215 can include multiple different types of memory with different performance characteristics. Processor 1210 can include any general purpose processor and a hardware or software service, such as service 1 1232, service 2 1234, and service 3 1236 stored in storage device 1230, configured to control processor 1210 as well as a special-purpose processor where software instructions are incorporated into the processor design. Processor 1210 may be a self-contained system, containing multiple cores or processors, a bus, memory controller, cache, etc. A multi-core processor may be symmetric or asymmetric.

To enable user interaction with the computing device architecture 1200, input device 1245 can represent any number of input mechanisms, such as a microphone for speech, a touch-sensitive screen for gesture or graphical input, keyboard, mouse, motion input, speech and so forth. Output device 1235 can also be one or more of a number of output mechanisms known to those of skill in the art, such as a display, projector, television, speaker device, etc. In some instances, multimodal computing devices can enable a user to provide multiple types of input to communicate with computing device architecture 1200. Communication interface 1240 can generally govern and manage the user input and computing device output. There is no restriction on operating on any particular hardware arrangement and therefore the basic features here may easily be substituted for improved hardware or firmware arrangements as they are developed.

Storage device 1230 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1225, read only memory (ROM) 1220, and hybrids thereof. Storage device 1230 can include services 1232, 1234, 1236 for controlling processor 1210. Other hardware or software modules are contemplated. Storage device 1230 can be connected to the computing device connection 1205. In some aspects, a hardware module that performs a particular function can include the software component stored in a computer-readable medium in connection with the necessary hardware components, such as processor 1210, connection 1205, output device 1235, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description. Where components are described as being “configured to” perform certain

operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus comprising: at least one memory; and a processing system coupled to the at least one memory and configured to: obtain sensor data from one or more sensors of the apparatus, wherein the apparatus is configured to implement a neural network (NN) model comprising a plurality of layers and a plurality of skip connections; determine, based on the sensor data, one or more skip connections from the plurality of skip connections, wherein the one or more skip connections correspond to a respective skippable portion of the NN model; and control the one or more skip connections while the processing system performs inference using the NN model, wherein the processing system is configured to control the one or more skip connections to implement a reduced configuration of the NN model, and wherein the reduced configuration of the NN model is implemented based on a reconfiguration of the NN model during the inference.

Aspect 2. The apparatus of Aspect 1, wherein the reduced configuration of the NN model does not include the respective skippable portion, and wherein the processing system is configured to: initiate one or more inference operations using a first configuration of the NN model, wherein the first configuration includes the respective skippable portion of the NN model; and implement the reduced configuration of the NN model based on using the one or more skip connections to implement the reconfiguration of the NN model.

Aspect 3. The apparatus of Aspect 2, wherein the processing system is configured to implement the reduced configuration of the NN model after initiation of the one or more inference operations using the first configuration.

Aspect 4. The apparatus of any of Aspects 2 to 3, wherein, to implement the reduced configuration of the NN model, the processing system is configured to: use the one or more skip connections to deactivate the respective skippable portion in the first configuration of the NN model.

Aspect 5. The apparatus of any of Aspects 2 to 4, wherein the reduced configuration of the NN model comprises the first configuration with the respective skippable portion removed.

Aspect 6. The apparatus of any of Aspects 2 to 5, wherein: the one or more skip connections are not used in the first configuration of the NN model; and the one or more skip connections are used in the reduced configuration of the NN model.

Aspect 7. The apparatus of Aspect 6, wherein: using the one or more skip connections in the reduced configuration of the NN model causes the processing system to perform the inference without using the respective skippable portion of the NN model.

Aspect 8. The apparatus of any of Aspects 1 to 7, wherein, to perform inference using the NN model, the processing system is configured to: implement a first configuration of the NN model based on a first sensor state determined using the one or more sensors; and implement the reduced configuration of the NN model based on a second sensor state determined based on the sensor data, where the sensor data is indicative of one or more configured changes from the first sensor state.

Aspect 9. The apparatus of Aspect 8, wherein the first configuration includes each respective layer of the plurality of layers, and wherein the reduced configuration comprises the plurality of layers with one or more layers corresponding to the respective skippable portion deactivated.

Aspect 10. The apparatus of Aspect 9, wherein the processing system is configured to: implement the first configuration of the NN model based on activating, for each respective layer of the plurality of layers, one or more processing elements of a plurality of processing elements of the apparatus; and implement the reduced configuration of the NN model based on deactivating the one or more processing elements corresponding to each skippable layer of one or more skippable layers included in the respective skippable portion of the NN model.

Aspect 11. The apparatus of any of Aspects 9 to 10, wherein, to deactivate the one or more processing elements corresponding to each skippable layer, the processing system is configured to: control a power supply node of the apparatus to switch off power supply to the respective one or more processing elements previously activated for each skippable layer of the one or more skippable layers included in the respective skippable portion of the NN model.

Aspect 12. The apparatus of any of Aspects 1 to 11, wherein, to obtain the sensor data, the processing system is configured to: obtain the sensor data after initiating one or more inference operations corresponding to the inference using the NN model; and implement the reduced configuration of the NN model without terminating at least one of: the one or more inference operations or the inference.

Aspect 13. The apparatus of any of Aspects 1 to 12, wherein the sensor data is associated with performance of the inference by the processing system.

Aspect 14. The apparatus of any of Aspects 1 to 13, wherein the processing system is configured to obtain the sensor data from the one or more sensors during the inference.

Aspect 15. The apparatus of any of Aspects 1 to 14, wherein the sensor data is indicative of at least one of: a temperature of one or more components of the processing system associated with the processing system performing the inference using the NN model, or a power consumption associated with the processing system performing the inference using the NN model.

Aspect 16. The apparatus of any of Aspects 1 to 15, wherein at least a portion of the sensor data is included in one or more respective inputs to the NN model during the inference.

Aspect 17. The apparatus of any of Aspects 1 to 16, wherein, to control the one or more skip connections, the processing system is configured to: open a respective power supply switch connected between the one or more skip connections and a power source of the apparatus, wherein opening the respective power supply switch deactivates at least a portion of the one or more skip connections and reconfigures the NN model to deactivate the respective skippable portion.

Aspect 18. The apparatus of any of Aspects 1 to 17, wherein, to control the one or more skip connections, the processing system is configured to: close a respective power supply switch connected between the one or more skip connections and a power source of the apparatus, wherein closing the respective power supply switch activates at least a portion of the one or more skip connections.

Aspect 19. The apparatus of any of Aspects 1 to 18, wherein: the processing system is configured to throttle the NN model during inference based on performing a power collapse of one or more layers corresponding to the respective skippable portion and included in the plurality of layers.

Aspect 20. The apparatus of Aspect 19, wherein the one or more skip connections and the one or more layers corresponding to the respective skippable portion are implemented using only local buffers or local data flip-flops (DFFs).

Aspect 21. The apparatus of any of Aspects 19 to 20, wherein, to perform the power collapse, the processing system is configured to: open one or more power supply switches corresponding to each skip connection of the one or more skip connections, wherein opening the one or more power supply switches disconnects a power supply from the apparatus to a portion of the processing system configured to implement the one or more layers corresponding to the respective skippable portion of the NN model.

Aspect 22. The apparatus of Aspect 21, wherein, to perform the power collapse, the processing system is configured to: preserve state information of one or more local buffers or local data flip-flops (DFFs) associated with an activation signal to the one or more skip connections or the one or more layers corresponding to the respective skippable portion.

Aspect 23. The apparatus of any of Aspects 1 to 22, wherein the processing system is configured to: process the sensor data using an auxiliary neural network implemented by the apparatus, wherein an output of the auxiliary neural network comprises a learnable threshold indicative of at least one of: the respective skippable portion of the NN model, or the one or more skip connections.

Aspect 24. The apparatus of Aspect 23, wherein, to control the one or more skip connections while the processing system performs the inference, the processing system is configured to: activate each respective skip connection of the one or more skip connections based on the output of the auxiliary neural network.

Aspect 25. The apparatus of any of Aspects 23 to 24, wherein the processing system is configured to: determine, using the auxiliary neural network and the sensor data, a selected subset of skip connections from the plurality of skip connections, wherein the selected subset of skip connections comprises the one or more skip connections; and control the selected subset of skip connections to perform a power collapse of one or more internal skip layers of the NN model, wherein the power collapse implements the reduced configuration of the NN model, and wherein the one or more internal skip layers comprise the respective skippable portion of the NN model.

Aspect 26. A method comprising: obtaining sensor data from one or more sensors of a processing system, wherein the processing system is configured to implement a neural network (NN) model comprising a plurality of layers and a plurality of skip connections; determining, based on the sensor data, one or more skip connections from the plurality of skip connections, wherein the one or more skip connections correspond to a respective skippable portion of the NN model; and controlling the one or more skip connections while the processing system performs inference using the NN model, wherein the processing system is configured to control the one or more skip connections to implement a reduced configuration of the NN model, and wherein the reduced configuration of the NN model is implemented based on a reconfiguration of the NN model during the inference.

Aspect 27. The method of Aspect 26 further comprising: initiating one or more inference operations using a first configuration of the NN model, wherein the first configuration includes the respective skippable portion of the NN model; and implementing the reduced configuration of the NN model based on using the one or more skip connections to implement the reconfiguration of the NN model, wherein the reduced configuration of the NN model does not include the respective skippable portion.

Aspect 28. The method of Aspect 27, further comprising implementing the reduced configuration of the NN model after initiation of the one or more inference operations using the first configuration.

Aspect 29. The method of any of Aspects 27 to 28, wherein implementing the reduced configuration of the NN model comprises: using the one or more skip connections to deactivate the respective skippable portion in the first configuration of the NN model.

Aspect 30. The method of any of Aspects 27 to 29, wherein the reduced configuration of the NN model comprises the first configuration with the respective skippable portion removed.

Aspect 31. The method of any of Aspects 27 to 30, wherein: the one or more skip connections are not used in the first configuration of the NN model; and the one or more skip connections are used in the reduced configuration of the NN model.

Aspect 32. The method of Aspect 31, wherein: using the one or more skip connections in the reduced configuration of the NN model comprises performing the inference without using the respective skippable portion of the NN model.

Aspect 33. The method of any of Aspects 26 to 32, wherein performing inference using the NN model comprises: implementing a first configuration of the NN model based on a first sensor state determined using the one or more sensors; and implementing the reduced configuration of the NN model based on a second sensor state determined based on the sensor data, where the sensor data is indicative of one or more configured changes from the first sensor state.

Aspect 34. The method of Aspect 33, wherein the first configuration includes each respective layer of the plurality of layers, and wherein the reduced configuration comprises the plurality of layers with one or more layers corresponding to the respective skippable portion deactivated.

Aspect 35. The method of Aspect 34, further comprising: implementing the first configuration of the NN model based on activating, for each respective layer of the plurality of layers, one or more processing elements of a plurality of processing elements of the processing system; and implementing the reduced configuration of the NN model based on deactivating the one or more processing elements corresponding to each skippable layer of one or more skippable layers included in the respective skippable portion of the NN model.

Aspect 36. The method of any of Aspects 34 to 35, wherein deactivating the one or more processing elements corresponding to each skippable layer comprises: controlling a power supply node of the processing system to switch off power supply to the respective one or more processing elements previously activated for each skippable layer of the one or more skippable layers included in the respective skippable portion of the NN model.

Aspect 37. The method of any of Aspects 26 to 36, wherein obtaining the sensor data comprises: obtaining the sensor data after initiating one or more inference operations corresponding to the inference using the NN model; and implementing the reduced configuration of the NN model without terminating at least one of: the one or more inference operations or the inference.

Aspect 38. The method of any of Aspects 26 to 37, wherein the sensor data is associated with performance of the inference by the processing system.

Aspect 39. The method of any of Aspects 26 to 38, further comprising obtaining the sensor data from the one or more sensors during the inference.

Aspect 40. The method of any of Aspects 26 to 39, wherein the sensor data is indicative of at least one of: a temperature of one or more components of the processing system associated with the processing system performing the inference using the NN model, or a power consumption associated with the processing system performing the inference using the NN model.

Aspect 41. The method of any of Aspects 26 to 40, wherein at least a portion of the sensor data is included in one or more respective inputs to the NN model during the inference.

Aspect 42. The method of any of Aspects 26 to 41, wherein controlling the one or more skip connections comprises: opening a respective power supply switch connected between the one or more skip connections and a power source, wherein opening the respective power supply switch deactivates at least a portion of the one or more skip connections and reconfigures the NN model to deactivate the respective skippable portion.

Aspect 43. The method of any of Aspects 26 to 42, wherein controlling the one or more skip connections comprises: closing a respective power supply switch connected between the one or more skip connections and a power source, wherein closing the respective power supply switch activates at least a portion of the one or more skip connections.

Aspect 44. The method of any of Aspects 26 to 43, wherein: the processing system is configured to throttle the NN model during inference based on performing a power collapse of one or more layers corresponding to the respective skippable portion and included in the plurality of layers.

Aspect 45. The method of Aspect 44, wherein the one or more skip connections and the one or more layers corresponding to the respective skippable portion are implemented using only local buffers or local data flip-flops (DFFs).

Aspect 46. The method of any of Aspects 44 to 45, wherein performing the power collapse comprises: opening one or more power supply switches corresponding to each skip connection of the one or more skip connections, wherein opening the one or more power supply switches disconnects a power supply to a portion of the processing system configured to implement the one or more layers corresponding to the respective skippable portion of the NN model.

Aspect 47. The method of Aspect 46, wherein performing the power collapse comprises: preserving state information of one or more local buffers or local data flip-flops (DFFs) associated with an activation signal to the one or more skip connections or the one or more layers corresponding to the respective skippable portion.

Aspect 48. The method of any of Aspects 26 to 47, further comprising: processing the sensor data using an auxiliary neural network implemented by the processing system, wherein an output of the auxiliary neural network comprises a learnable threshold indicative of at least one of: the respective skippable portion of the NN model, or the one or more skip connections.

Aspect 49. The method of Aspect 48, wherein controlling the one or more skip connections while the processing system performs the inference comprises activating each respective skip connection of the one or more skip connections based on the output of the auxiliary neural network.

Aspect 50. The method of any of Aspects 48 to 49, further comprising: determining, using the auxiliary neural network and the sensor data, a selected subset of skip connections from the plurality of skip connections, wherein the selected subset of skip connections comprises the one or more skip connections; and controlling the selected subset of skip connections to perform a power collapse of one or more internal skip layers of the NN model, wherein the power collapse implements the reduced configuration of the NN model, and wherein the one or more internal skip layers comprise the respective skippable portion of the NN model.

Aspect 51. A non-transitory computer-readable storage medium comprising instructions stored thereon which, when executed by at least one processor, causes the at least one processor to perform operations according to any of Aspects 26 to 50.

Aspect 52. An apparatus comprising one or more means for performing operations according to any of Aspects 26 to 50.

What is claimed is:

1. An apparatus comprising:
at least one memory; and
a processing system coupled to the at least one memory and configured to:
obtain sensor data from one or more sensors of the apparatus, wherein the apparatus is configured to implement a neural network (NN) model comprising a plurality of layers and a plurality of skip connections;
determine, based on the sensor data, one or more skip connections from the plurality of skip connections, wherein the one or more skip connections correspond to a respective skippable portion of the NN model; and
control the one or more skip connections while the processing system performs inference using the NN model, wherein the processing system is configured to control the one or more skip connections to implement a reduced configuration of the NN model, and wherein the reduced configuration of the NN model is implemented based on a reconfiguration of the NN model during the inference.

2. The apparatus of claim 1, wherein the reduced configuration of the NN model does not include the respective skippable portion, and wherein the processing system is configured to:
initiate one or more inference operations using a first configuration of the NN model, wherein the first configuration includes the respective skippable portion of the NN model; and
implement the reduced configuration of the NN model based on using the one or more skip connections to implement the reconfiguration of the NN model.

3. The apparatus of claim 2, wherein:
the processing system is configured to implement the reduced configuration of the NN model after initiation of the one or more inference operations using the first configuration; and
to implement the reduced configuration of the NN model, the processing system is configured to use the one or more skip connections to deactivate the respective skippable portion in the first configuration of the NN model.

4. The apparatus of claim 2, wherein:
the one or more skip connections are not used in the first configuration of the NN model; and
the one or more skip connections are used in the reduced configuration of the NN model, wherein using the one or more skip connections in the reduced configuration of the NN model causes the processing system to perform the inference without using the respective skippable portion of the NN model.

5. The apparatus of claim 1, wherein, to perform inference using the NN model, the processing system is configured to:
implement a first configuration of the NN model based on a first sensor state determined using the one or more sensors; and
implement the reduced configuration of the NN model based on a second sensor state determined based on the sensor data, where the sensor data is indicative of one or more configured changes from the first sensor state.

6. The apparatus of claim 5, wherein the first configuration includes each respective layer of the plurality of layers, and wherein the reduced configuration comprises the plurality of layers with one or more layers corresponding to the respective skippable portion deactivated.

7. The apparatus of claim 6, wherein the processing system is configured to:
implement the first configuration of the NN model based on activating, for each respective layer of the plurality of layers, one or more processing elements of a plurality of processing elements of the apparatus; and
implement the reduced configuration of the NN model based on deactivating the one or more processing elements corresponding to each skippable layer of one or more skippable layers included in the respective skippable portion of the NN model.

8. The apparatus of claim 6, wherein, to deactivate the one or more processing elements corresponding to each skippable layer, the processing system is configured to:
control a power supply node of the apparatus to switch off power supply to the respective one or more processing elements previously activated for each skippable layer of the one or more skippable layers included in the respective skippable portion of the NN model.

9. The apparatus of claim 1, wherein, to obtain the sensor data, the processing system is configured to:
obtain the sensor data after initiating one or more inference operations corresponding to the inference using the NN model; and
implement the reduced configuration of the NN model without terminating at least one of: the one or more inference operations or the inference.

10. The apparatus of claim 1, wherein the sensor data is associated with performance of the inference by the processing system, and wherein at least a portion of the sensor data is included in one or more respective inputs to the NN model during the inference.

11. The apparatus of claim 1, wherein the sensor data is indicative of at least one of: a temperature of one or more components of the processing system associated with the processing system performing the inference using the NN model, or a power consumption associated with the processing system performing the inference using the NN model.

12. The apparatus of claim 1, wherein, to control the one or more skip connections, the processing system is configured to:
open a respective power supply switch connected between the one or more skip connections and a power source of the apparatus, wherein opening the respective power supply switch deactivates at least a portion of the one or more skip connections and reconfigures the NN model to deactivate the respective skippable portion.

13. The apparatus of claim 1, wherein, to control the one or more skip connections, the processing system is configured to:
close a respective power supply switch connected between the one or more skip connections and a power source of the apparatus, wherein closing the respective power supply switch activates at least a portion of the one or more skip connections.

14. The apparatus of claim 1, wherein:
the processing system is configured to throttle the NN model during inference based on performing a power collapse of one or more layers corresponding to the respective skippable portion and included in the plurality of layers.

15. The apparatus of claim 14, wherein, to perform the power collapse, the processing system is configured to:
open one or more power supply switches corresponding to each skip connection of the one or more skip connections, wherein opening the one or more power supply switches disconnects a power supply from the apparatus to a portion of the processing system configured to implement the one or more layers corresponding to the respective skippable portion of the NN model.

16. The apparatus of claim 15, wherein, to perform the power collapse, the processing system is configured to:
preserve state information of one or more local buffers or local data flip-flops (DFFs) associated with an activation signal to the one or more skip connections or the one or more layers corresponding to the respective skippable portion.

17. The apparatus of claim 1, wherein the processing system is configured to:
process the sensor data using an auxiliary neural network implemented by the apparatus, wherein an output of the auxiliary neural network comprises a learnable threshold indicative of at least one of: the respective skippable portion of the NN model, or the one or more skip connections.

18. The apparatus of claim 17, wherein, to control the one or more skip connections while the processing system performs the inference, the processing system is configured to: activate each respective skip connection of the one or more skip connections based on the output of the auxiliary neural network.

19. The apparatus of claim 17, wherein the processing system is configured to:
determine, using the auxiliary neural network and the sensor data, a selected subset of skip connections from the plurality of skip connections, wherein the selected subset of skip connections comprises the one or more skip connections; and
control the selected subset of skip connections to perform a power collapse of one or more internal skip layers of the NN model, wherein the power collapse implements the reduced configuration of the NN model, and wherein the one or more internal skip layers comprise the respective skippable portion of the NN model.

20. A method comprising:
obtaining sensor data from one or more sensors of a processing system, wherein the processing system is configured to implement a neural network (NN) model comprising a plurality of layers and a plurality of skip connections;
determining, based on the sensor data, one or more skip connections from the plurality of skip connections, wherein the one or more skip connections correspond to a respective skippable portion of the NN model; and
controlling the one or more skip connections while the processing system performs inference using the NN model, wherein the processing system is configured to control the one or more skip connections to implement a reduced configuration of the NN model, and wherein the reduced configuration of the NN model is implemented based on a reconfiguration of the NN model during the inference.
